(19) United States
(12) Patent Application Publication
(10) Pub. No.: US 2025/0227763 A1
(43) Pub. Date: Jul. 10, 2025

(54) PROBABILITY-BASED RANDOM ACCESS PROCEDURES

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US); Tao LUO, San Diego, CA (US)

(21) Appl. No.: 18/849,350

(22) PCT Filed: May 16, 2022
(86) PCT No.: PCT/CN2022/092966

§ 371 Date: Sep. 20, 2024

(51) Int. Cl. H04W 74/0833; H04W 56/00

(52) U.S. Cl. CPC H04W 74/0833; H04W 56/001

(57) ABSTRACT

Various aspects of the present disclosure generally relate to wireless communication. In some aspects, a user equipment (UE) may receive an initial set of probabilities, associated with a first set of synchronization signal blocks (SSBs), indicating chances of using SSBs within the first set for a random access procedure. The UE may determine an updated set of probabilities, associated with a second set of SSBs, based on the initial set of probabilities and indicating chances of using SSBs within the second set for the random access procedure. Accordingly, the UE may perform the random access procedure with an SSB selected from the second set of SSBs. Numerous other aspects are described.

### FIELD OF THE DISCLOSURE

Aspects of the present disclosure generally relate to wireless communication and to techniques and apparatuses for probability-based random access procedures.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an initial set of probabilities, associated with a first set of synchronization signal blocks (SSBs), indicating chances of using SSBs within the first set for a random access procedure. The method may include determining an updated set of probabilities, associated with a second set of SSBs, based on the initial set of probabilities and indicating chances of using SSBs within the second set for the random access procedure. The method may include performing the random access procedure with an SSB selected from the second set of SSBs.

Some aspects described herein relate to a method of wireless communication performed by a network entity. The method may include transmitting an initial set of probabilities, associated with a first set of SSBs, indicating chances of using SSBs within the first set for a random access procedure. The method may include performing, with a UE, the random access procedure with an SSB that was selected based at least in part on the initial set of probabilities.

Some aspects described herein relate to an apparatus for wireless communication at a UE. The apparatus may include a memory and one or more processors coupled to the memory. The one or more processors may be configured to receive an initial set of probabilities, associated with a first set of SSBs, indicating chances of using SSBs within the first set for a random access procedure. The one or more processors may be configured to determine an updated set of probabilities, associated with a second set of SSBs, based on the initial set of probabilities and indicating chances of using SSBs within the second set for the random access procedure. The one or more processors may be configured to perform the random access procedure with an SSB selected from the second set of SSBs.

Some aspects described herein relate an apparatus for wireless communication at a network entity. The apparatus may include a memory and one or more processors coupled to the memory. The one or more processors may be configured to transmit an initial set of probabilities, associated with a first set of SSBs, indicating chances of using SSBs within the first set for a random access procedure. The one or more processors may be configured to perform, with a UE, the random access procedure with an SSB that was selected based at least in part on the initial set of probabilities.

Some aspects described herein relate to a non-transitory computer-readable medium that stores a set of instructions for wireless communication by a UE. The set of instructions, when executed by one or more processors of the UE, may cause the UE to receive an initial set of probabilities, associated with a first set of SSBs, indicating chances of using SSBs within the first set for a random access procedure. The set of instructions, when executed by one or more processors of the UE, may cause the UE to determine an updated set of probabilities, associated with a second set of SSBs, based on the initial set of probabilities and indicating chances of using SSBs within the second set for the random access procedure. The set of instructions, when executed by one or more processors of the UE, may cause the UE to perform the random access procedure with an SSB selected from the second set of SSBs.

Some aspects described herein relate to a non-transitory computer-readable medium that stores a set of instructions for wireless communication by a network entity. The set of instructions, when executed by one or more processors of the network entity, may cause the network entity to transmit an initial set of probabilities, associated with a first set of SSBs, indicating chances of using SSBs within the first set for a random access procedure. The set of instructions, when executed by one or more processors of the network entity, may cause the network entity to perform, with a UE, the random access procedure with an SSB that was selected based at least in part on the initial set of probabilities.

Some aspects described herein relate to an apparatus for wireless communication. The apparatus may include means for receiving an initial set of probabilities, associated with a first set of SSBs, indicating chances of using SSBs within the first set for a random access procedure. The apparatus may include means for determining an updated set of probabilities, associated with a second set of SSBs, based on the initial set of probabilities and indicating chances of using SSBs within the second set for the random access procedure. The apparatus may include means for performing the random access procedure with an SSB selected from the second set of SSBs.

Some aspects described herein relate to an apparatus for wireless communication. The apparatus may include means for transmitting an initial set of probabilities, associated with a first set of SSBs, indicating chances of using SSBs within the first set for a random access procedure. The apparatus may include means for performing, with a UE, the random access procedure with an SSB that was selected based at least in part on the initial set of probabilities.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of a 4-step random access procedure, in accordance with the present disclosure.

FIG. 5 is a diagram illustrating an example of a 2-step random access procedure, in accordance with the present disclosure.

FIGS. 6 and 7 are diagrams illustrating examples associated with probability-based random access procedures, in accordance with the present disclosure.

FIG. 8 is a diagram illustrating an example associated with updating probabilities for random access procedures, in accordance with the present disclosure.

FIG. 9 is a diagram illustrating an example associated with concurrent and timer-based random access procedures, in accordance with the present disclosure.

FIGS. 10 and 11 are diagrams illustrating example processes associated with probability-based random access procedures, in accordance with the present disclosure.

FIGS. 12 and 13 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

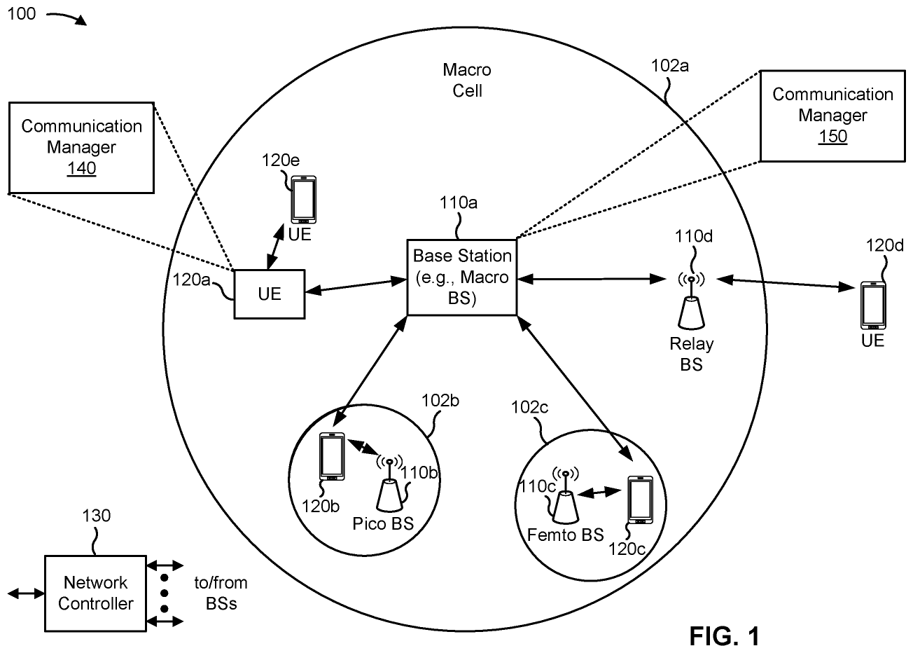

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

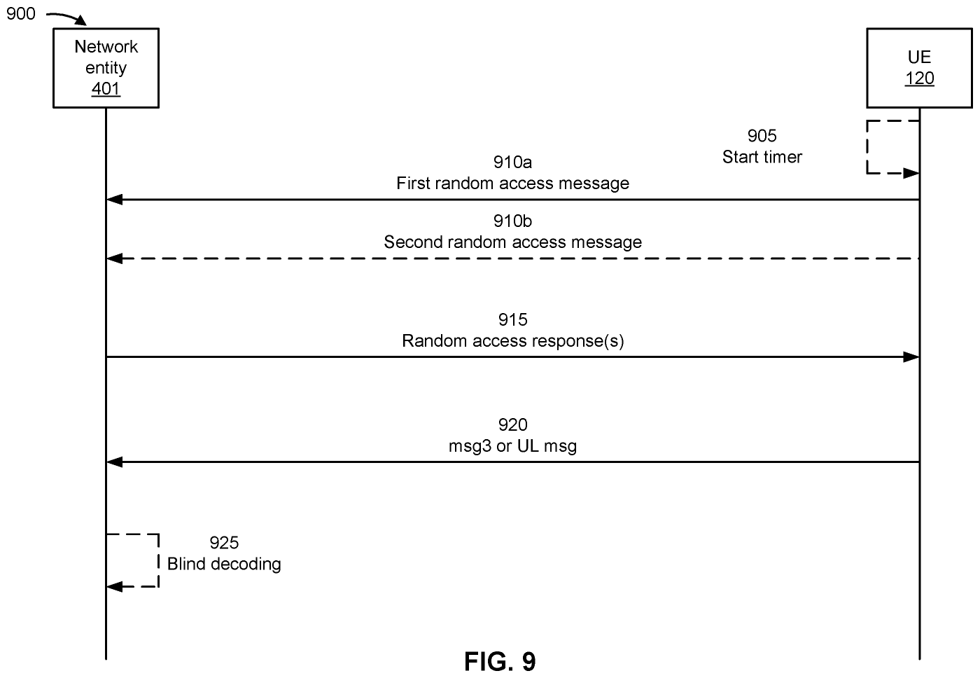

In some aspects, the term “base station” (e.g., the base station 110) or “network node” or “network entity” may refer to an aggregated base station, a disaggregated base station (e.g., described in connection with FIG. 9), an integrated access and backhaul (IAB) node, a relay node, and/or one or more components thereof. For example, in some aspects, “base station,” “network node,” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station,” “network node,” or “network entity” may refer to one device configured to perform one or more functions, such as those described herein in connection with the base station 110. In some aspects, the term “base station,” “network node,” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station,” “network node,” or “network entity” may refer to any one or more of those different devices. In some aspects, the term “base station,” “network node,” or “network entity” may refer to one or more virtual base stations and/or one or more virtual base station functions. For example, in some aspects, two or more base station functions may be instantiated on a single device. In some aspects, the term “base station,” “network node,” or “network entity” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular radio access technology (RAT) and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, New Ratio (NR) or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an initial set of probabilities, associated with a first set of synchronization signal blocks (SSBs), indicating chances of using SSBs within the first set for a random access procedure; determine an updated set of probabilities, associated with a second set of SSBs, based on the initial set of probabilities and indicating chances of using SSBs within the second set for the random access procedure; and perform the random access procedure with an SSB selected from the second set of SSBs. Additionally, or alternatively, the communication manager 140 may perform one or more other operations described herein.

In some aspects, a network entity (e.g., the base station 110) may include a communication manager 150. As described in more detail elsewhere herein, the communication manager 150 may transmit an initial set of probabilities, associated with a first set of SSBs, indicating chances of using SSBs within the first set for a random access procedure; and perform, with the UE 120, the random access procedure with an SSB that was selected based at least in part on the initial set of probabilities. Additionally, or alternatively, the communication manager 150 may perform one or more other operations described herein.

As indicated above, FIG. 1 is provided as an example. Other examples may differ from what is described with regard to FIG. 1.

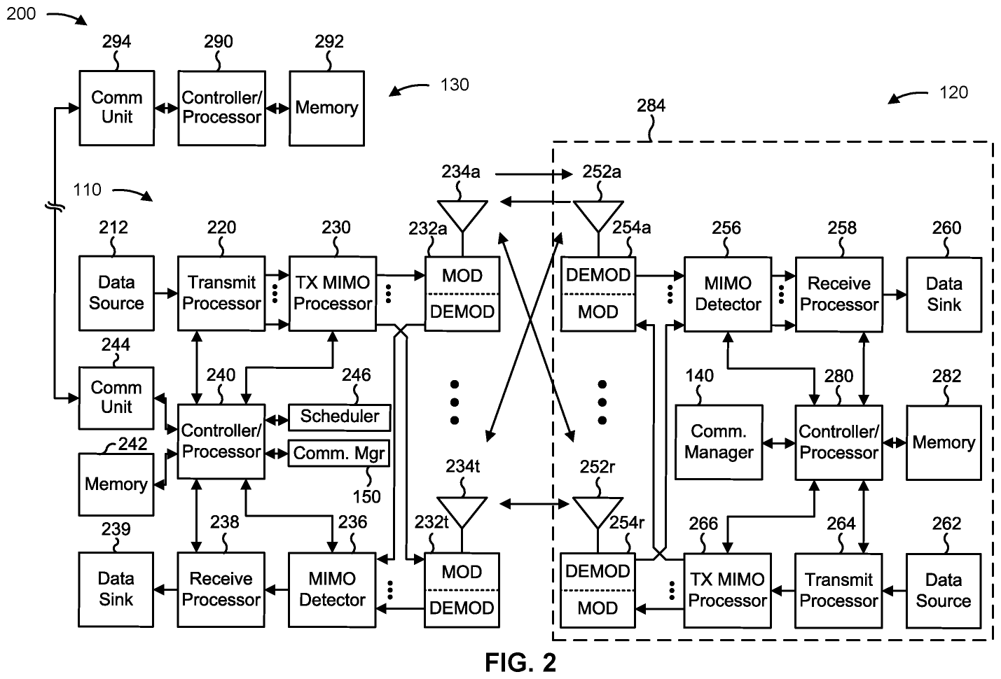

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

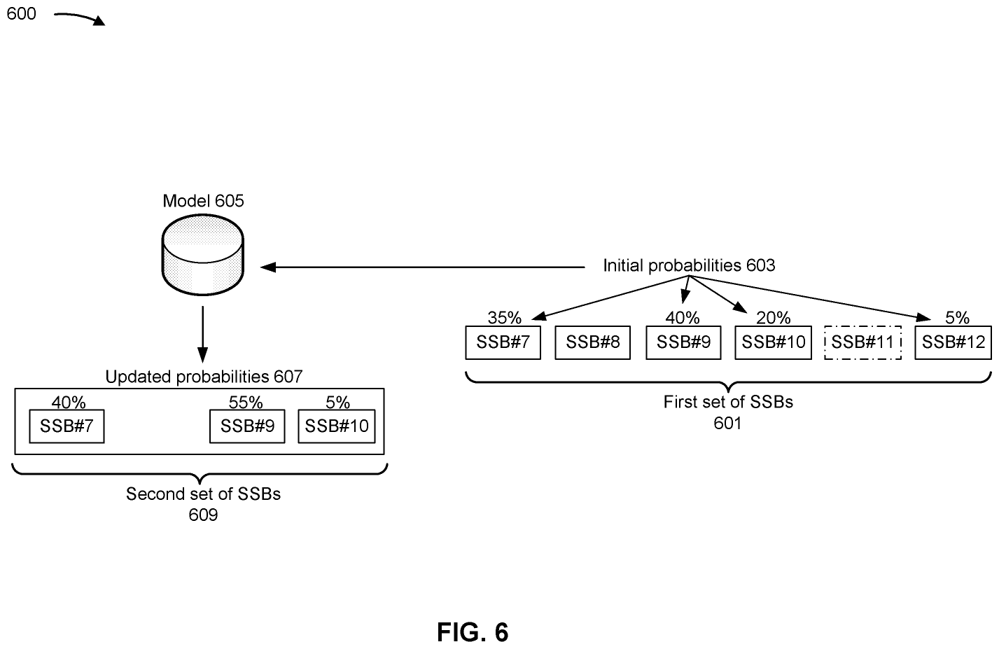

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-13).

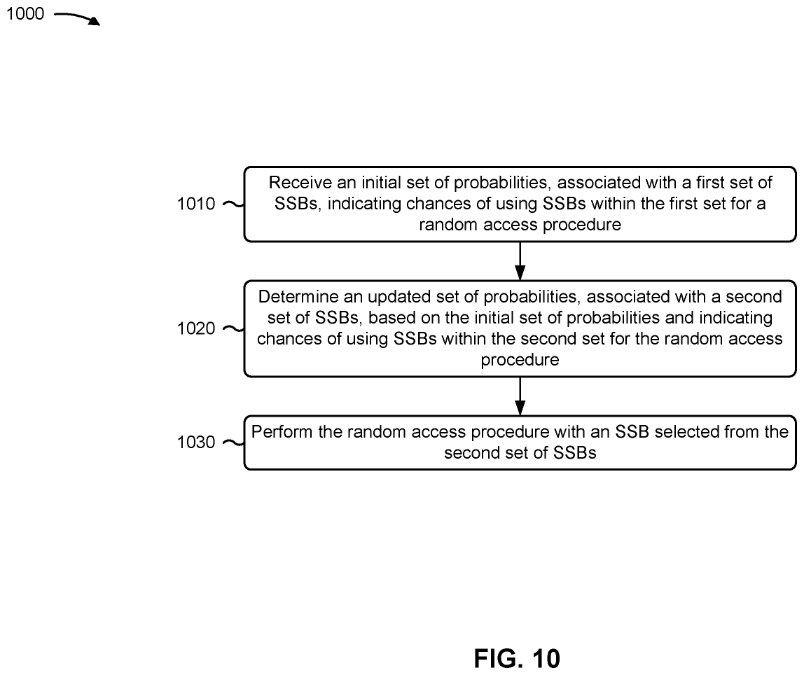

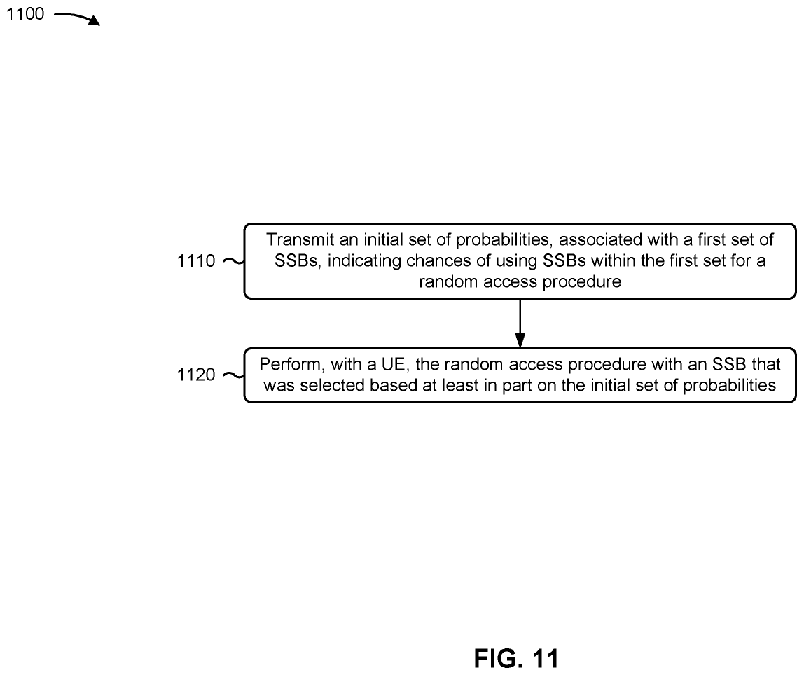

The controller/processor 240 of the base station 110, the controller/processor 280 of the UE 120, and/or any other component(s) of FIG. 2 may perform one or more techniques associated with probability-based random access procedures, as described in more detail elsewhere herein. For example, the controller/processor 240 of the base station 110, the controller/processor 280 of the UE 120, and/or any other component(s) of FIG. 2 may perform or direct operations of, for example, process 1000 of FIG. 10, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, and/or other processes as described herein. In some examples, executing instructions may include running the instructions, converting the instructions, compiling the instructions, and/or interpreting the instructions, among other examples. In some aspects, the network entity described herein is the base station 110, is included in the base station 110, or includes one or more components of the base station 110 shown in FIG. 2.

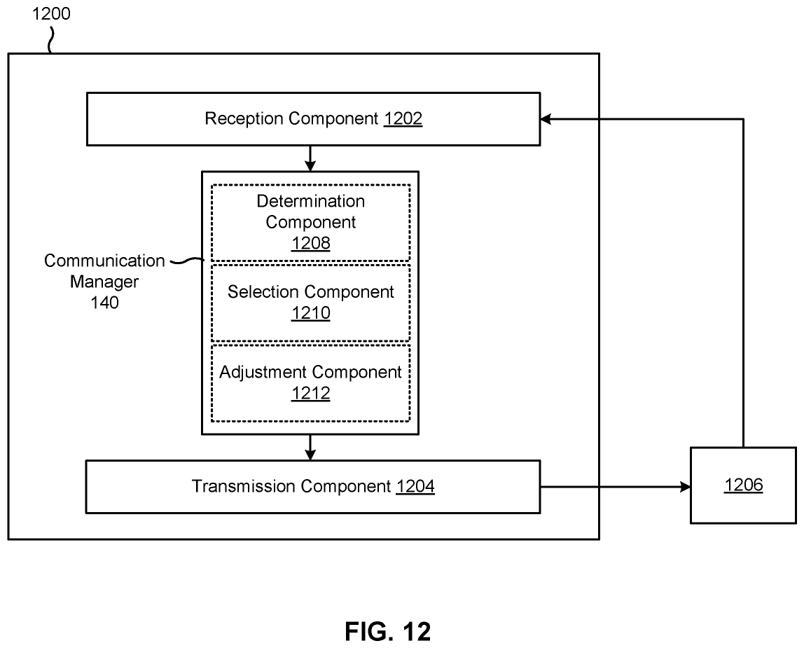

In some aspects, a UE (e.g., UE 120 and/or apparatus 1200 of FIG. 12) may include means for receiving an initial set of probabilities, associated with a first set of synchronization signal blocks (SSBs), indicating chances of using SSBs within the first set for a random access procedure; means for determining an updated set of probabilities, associated with a second set of SSBs, based on the initial set of probabilities and indicating chances of using SSBs within the second set for the random access procedure; and/or means for performing the random access procedure with an SSB selected from the second set of SSBs. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

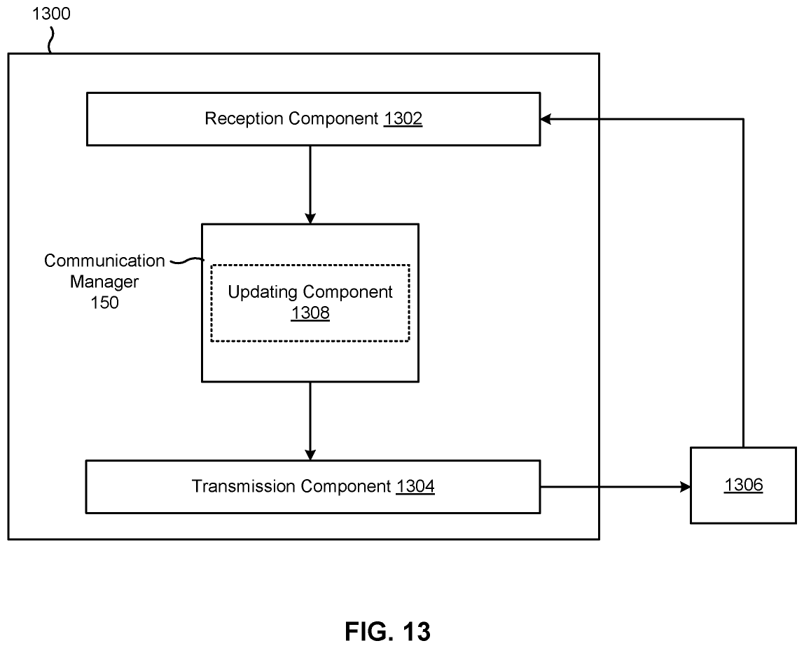

In some aspects, a network entity (e.g., base station 110, CU 310, DU 330, RU 340, and/or apparatus 1300 of FIG. 13) may include means for transmitting an initial set of probabilities, associated with a first set of SSBs, indicating chances of using SSBs within the first set for a random access procedure; and/or means for performing, with a UE (e.g., UE 120 and/or apparatus 1200 of FIG. 12), the random access procedure with an SSB that was selected based at least in part on the initial set of probabilities. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

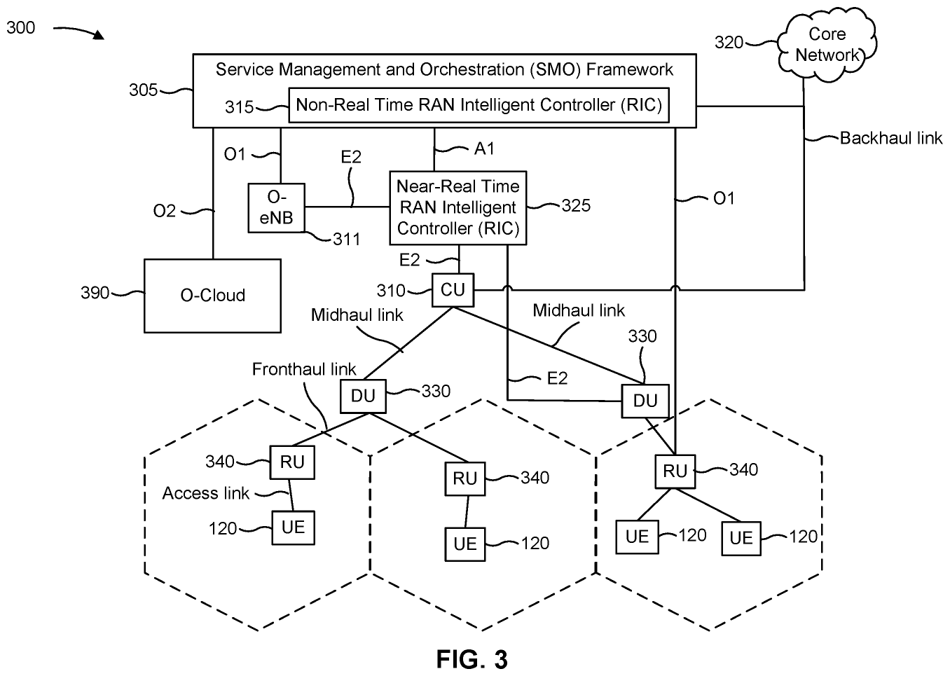

FIG. 3 is a diagram illustrating an example 300 disaggregated base station architecture, in accordance with the present disclosure. Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

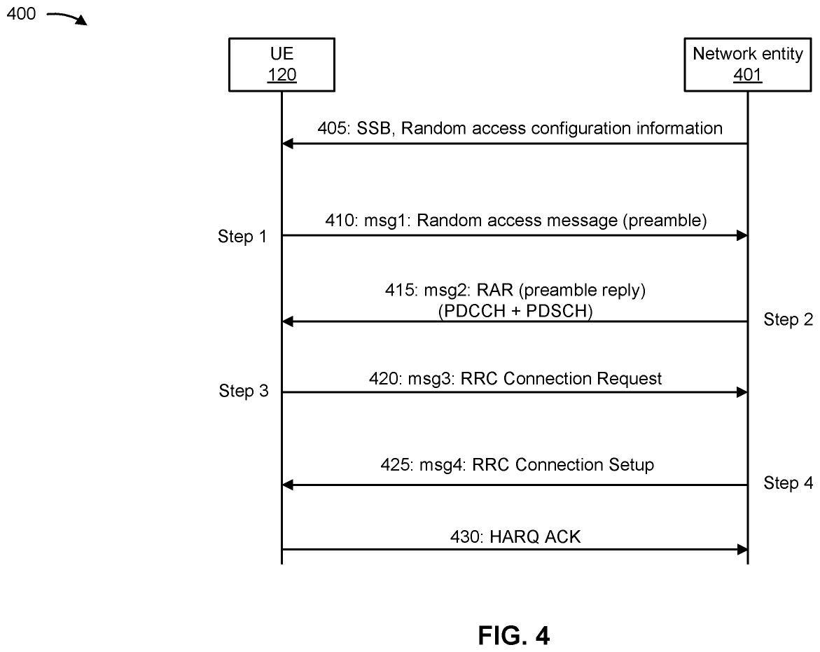

FIG. 4 is a diagram illustrating an example 400 of a four-step random access procedure, in accordance with the present disclosure. As shown in FIG. 4, a network entity 401 (e.g., an RU 340 and/or a device controlling the RU 340, such as a CU 310 and/or DU 330) and a UE 120 may communicate with one another to perform the four-step random access procedure.

As shown by reference number 405, the network entity 401 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a physical downlink control channel (PDCCH) order message that triggers a random access channel (RACH) procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 410, the UE 120 may transmit a RAM, which may include a preamble (sometimes referred to as a random access preamble, a physical RACH (PRACH) preamble, or a RAM preamble). The message that includes the preamble may be referred to as a message 1, msg1, MSG1, a first message, or an initial message in a four-step random access procedure. The random access message may include a random access preamble identifier.

Some techniques and apparatuses described herein enable the UE 120 to use probabilities to select an SSB for transmitting the RAM. For example, the UE 120 may receive a priori probabilities from the network entity 401, derive a posteriori probabilities (e.g., using a model), and select the SSB based on the a posteriori probabilities. Selecting the SSB includes using the random access occasion (RO) and the random access preamble associated with the selected SSB to initiate a random access procedure with the network entity 401.

As shown by reference number 415, the network entity 401 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network entity 401 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the network entity 401 may transmit the PDSCH communication for the RAR, as scheduled by the PDCCH communication. The RAR may be included in a MAC protocol data unit (PDU) of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, uplink control information (UCI), and/or a physical uplink shared channel (PUSCH) communication (e.g., an RRC connection request).

As shown by reference number 425, the network entity 401 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) acknowledgement (ACK).

As indicated above, FIG. 4 is provided as an example. Other examples may differ from what is described with regard to FIG. 4.

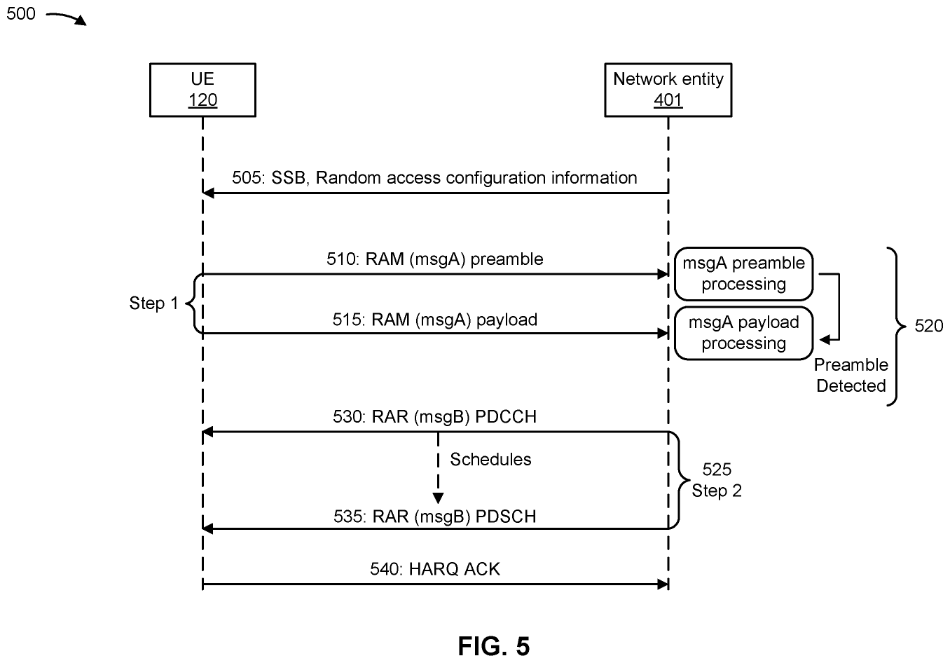

FIG. 5 is a diagram illustrating an example 500 of a two-step random access procedure, in accordance with the present disclosure. As shown in FIG. 5, a network entity 401 and a UE 120 may communicate with one another to perform the two-step random access procedure.

As shown by reference number 505, the network entity 401 may transmit, and the UE 120 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a RAM and/or receiving an RAR to the RAM.

As shown by reference number 510, the UE 120 may transmit, and the network entity 401 may receive, a RAM preamble. As shown by reference number 515, the UE 120 may transmit, and the network entity 401 may receive, a RAM payload. As shown, the UE 120 may transmit the RAM preamble and the RAM payload to the network entity 401 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a physical random access channel (PRACH) preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, and/or a PUSCH transmission).

Some techniques and apparatuses described herein enable the UE 120 to use probabilities to select an SSB for transmitting the RAM. For example, the UE 120 may receive a priori probabilities from the network entity 401, derive a posteriori probabilities (e.g., using a model), and select the SSB based on the a posteriori probabilities. Selecting the SSB includes using the RO and the random access preamble associated with the selected SSB to initiate a random access procedure with the network entity 401.

As shown by reference number 520, the network entity 401 may receive the RAM preamble transmitted by the UE 120. If the network entity 401 successfully receives and decodes the RAM preamble, the network entity 401 may then receive and decode the RAM payload.

As shown by reference number 525, the network entity 401 may transmit an RAR (sometimes referred to as an RAR message). As shown, the network entity 401 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As shown by reference number 530, as part of the second step of the two-step random access procedure, the network entity 401 may transmit a PDCCH communication for the RAR. The PDCCH communication may schedule a PDSCH communication that includes the RAR. For example, the PDCCH communication may indicate a resource allocation (e.g., in downlink control information (DCI)) for the PDSCH communication.

As shown by reference number 535, as part of the second step of the two-step random access procedure, the network entity 401 may transmit the PDSCH communication for the RAR, as scheduled by the PDCCH communication. The RAR may be included in a MAC PDU of the PDSCH communication. As shown by reference number 540, if the UE 120 successfully receives the RAR, the UE 120 may transmit a HARQ ACK.

As indicated above, FIG. 5 is provided as an example. Other examples may differ from what is described with regard to FIG. 5.

Some techniques and apparatuses described herein enable a UE (e.g., UE 120 and/or apparatus 1200 of FIG. 12) to apply probabilities to select an SSB to use for a random access procedure. For example, a network entity (e.g., network entity 401, base station 110, CU 310, DU 330, RU 340, and/or apparatus 1300 of FIG. 13) may provide a priori probabilities to the UE 120 such that the UE 120 determines a posteriori probabilities (e.g., using a model) and selects the SSB based on the a posteriori probabilities. As a result, latency before the UE 120 establishes a RACH with the network entity 401 is reduced. Additionally, the UE 120 avoids selecting an SSB that is less likely to result in a successful random access procedure, which conserves power and processing resources that otherwise would have been consumed by one or more failed random access procedures.

FIG. 6 is a diagram illustrating an example 600 associated with probability-based random access procedures, in accordance with the present disclosure. As shown in FIG. 6, example 600 includes a first set of SSBs 601. As used herein, “SSB” refers to a signal that carries information used for initial network acquisition and synchronization, such as a primary synchronization signal (PSS), a secondary synchronization signal (SSS), a physical broadcast channel (PBCH), and a PBCH DMRS. The PBCH may carry a master information block (MIB) including information used by a UE (e.g., UE 120) to access the network via a network entity (e.g., a network entity 401, such as an RU 340 and/or a device controlling the RU 340 like a CU 310 and/or DU 330). For example, the MIB includes frequency and timing information to allow the UE 120 to connect to a cell including the network entity 401. Accordingly, an SSB is sometimes referred to as a synchronization signal/PBCH (SS/PBCH) block.

The first set of SSBs 601 may include all SSBs broadcast by the network. Alternatively, as shown in FIG. 6, the first set of SSBs 601 may include some (but not all) of the SSBs broadcast by the network. In some aspects, the UE 120 may select one or more SSBs to include in the first set of SSBs 601. For example, the UE 120 may perform measurements (e.g., RSRP measurements and/or other similar layer 1 (L1) measurements) and select the one or more SSBs associated with the highest measurements to include in the first set of SSBs 601. In example 600, the SSB associated with index 8 may be the SSB with the highest RSRP. Additionally, or alternatively, the UE 120 may decode the MIB (and/or monitor for the SIB1 according to the decoded MIB) using a selected SSB and include the selected SSB in the first set of SSBs 601. In example 600, the SSB associated with index 11 may be the SSB used to decode system information (e.g., the MIB and/or the SIB1).

Additionally, or alternatively, the network entity 401 may indicate one or more SSBs to include in the first set of SSBs 601. For example, the network entity 401 may indicate the one or more SSBs to include in the first set of SSBs 601 in the MIB, in remaining minimum system information (RMSI) (e.g., included in an initial SIB, also referred to as a SIB1), and/or in other system information (OSI) (e.g., included in a subsequent SIB, such as a SIB2, a SIB3, and so on).

As further shown in FIG. 6, the first set of SSBs 601 may be associated with an initial set of probabilities 603 indicating chances of using SSBs within the first set of SSBs 601 for a random access procedure. The initial set of probabilities 603 may be a priori probabilities that the UE 120 receives from the network entity 401. For example, the network entity 401 may indicate the initial set of probabilities 603 in the MIB, in RMSI (e.g., included in an initial SIB, also referred to as a SIB1), and/or in OSI (e.g., included in a subsequent SIB, such as a SIB2, a SIB3, and so on). For example, the network entity 401 may track historical information associated with successful random access procedures of UEs within the cell and derive the a priori probabilities based on which SSBs were used in the successful random access procedures. The historical information may be limited by a time window (e.g., within the previous one hour only, within the previous half-hour only, among other examples). Additionally, in some aspects, the network entity 401 may parse the historical information by geographic location such that the a priori probabilities are different depending on a location of the UE 120 (e.g., the network entity 401 may associate different a priori probabilities with different SSBs, as described below, such that the UE 120 is likely to select an SSB directed toward the UE 120 in order to receive the a priori probabilities). Additionally, or alternatively, the network entity 401 may parse the historical information by weather and/or other environmental information such that the a priori probabilities are different depending on a current weather pattern in the cell.

Using the initial set of probabilities 603, the UE 120 may apply a model 605 to determine an updated set of probabilities 607 associated with a second set of SSBs 609. The updated set of probabilities 607 may be a posteriori probabilities that the UE 120 derives. In some aspects, the UE 120 may apply the model 605 to select an SSB, from the second set of SSBs 609, for performing a first random access procedure. Alternatively, the UE 120 may apply the model 605 after a previous random access procedure (e.g., using an initial SSB selected based on a signal strength, such as an RSRP measurement, associated with the initial SSB) has failed.

The second set of SSBs 609 may be the same as the first set of SSBs 601. For example, the UE 120 may use a stored (and/or otherwise preconfigured) rule to use the first set of SSBs 601 as the second set of SSBs 609. Alternatively, as shown in FIG. 6, the second set of SSBs 609 may be a subset of the first set of SSBs 601. For example, the UE 120 may use a stored (and/or otherwise preconfigured) threshold to determine which SSBs in the first set of SSBs 601 are not included in the second set of SSBs 609. In one example, the threshold may be a quantity threshold such that the quantity of SSBs included in the second set of SSBs 609 satisfies the quantity threshold. In another example, the threshold may be a probability threshold such that each SSB included in the second set of SSBs 609 is associated with an a posteriori probability that satisfies the probability threshold. Relatedly, the model 605 may determine which SSBs to include in the second set of SSBs 609 as well the updated set of probabilities 607.

Alternatively, the second set of SSBs 609 may include all SSBs broadcast by the network. For example, the UE 120 may use a stored (and/or otherwise preconfigured) rule to use all SSBs broadcast by the network as the second set of SSBs 609. Alternatively, the UE 120 may receive an indication of SSBs to include in the second set of SSBs 609 from the network entity 401. For example, the network entity 401 may indicate the second set of SSBs 609 in the MIB, in RMSI (e.g., included in an initial SIB, also referred to as a SIB1), and/or in OSI (e.g., included in a subsequent SIB, such as a SIB2, a SIB3, and so on).

The model 605 may include an analytical model (e.g., a Bayesian model that updates the initial set of probabilities 603 based on subsequent measurements by the UE 120). Additionally, or alternatively, the model 605 may include a machine learning model (e.g., a neural network that updates the initial set of probabilities 603 based on inputs). For initial access, the machine learning model may be programmed (and/or otherwise preconfigured) into a memory of the UE 120. However, when determining which SSB to use for secondary cell group (SCG) configuration, the UE 120 may receive an indication of (or a payload including) a machine learning model to apply from the network entity 401. As used herein, “master cell group” or “MCG” may include at least a primary cell (PCell) that manages a control plane for the UE 120. In some aspects, the PCell may also manage a data plane for the UE 120 (e.g., in combination with or as a backup to the data plane managed by a primary secondary cell (PSCell)). As used herein, “secondary cell group” or “SCG” may include at least one secondary cell (SCell), such as a PSCell, that manages a data plane for the UE 120. The UE 120 may be configured for carrier aggregation with the SCell and the PCell.

The model 605 may accept, as input, one or more of: an index associated with an initial SSB (e.g., associated with a highest signal strength measurement and/or used to decode system information), and the set of initial probabilities 603; measurements (e.g., RSRPs) associated with the first set of SSBs 601, the second set of SSBs 609, and/or all SSBs broadcast by the network; or one or more indices associated with one or more SSBs used in one or more previous unsuccessful random access procedures, if any. Accordingly, the model 605 may output one or more indices associated with one or more SSBs included in the second set of SSBs 609, the updated set of probabilities 607, or a combination thereof.

In some aspects, the model 605 may be cell-common. As used herein, “cell-common” refers to a model that is used for a cell including the network entity 401. For example, the model 605 may apply no matter which SSB the UE 120 uses as an initial SSB (e.g., to decode system information). Alternatively, the model 605 may be selected based on which SSB the UE 120 uses as the initial SSB (e.g., to decode system information).

Accordingly, the UE 120 may perform a random access procedure with an SSB selected from the second set of SSBs 609. In example 600, the UE 120 may select the SSB associated with index 9. By using techniques as described in connection with FIG. 6, the UE 120 applies probabilities to select the SSB to use for the random access procedure. As a result, latency before the UE 120 establishes a RACH with the network entity 401 is reduced. Additionally, the UE 120 avoids selecting an SSB that is less likely to result in a successful random access procedure, which conserves power and processing resources that otherwise would have been consumed by one or more failed random access procedures.

As indicated above, FIG. 6 is provided as an example. Other examples may differ from what is described with respect to FIG. 6.

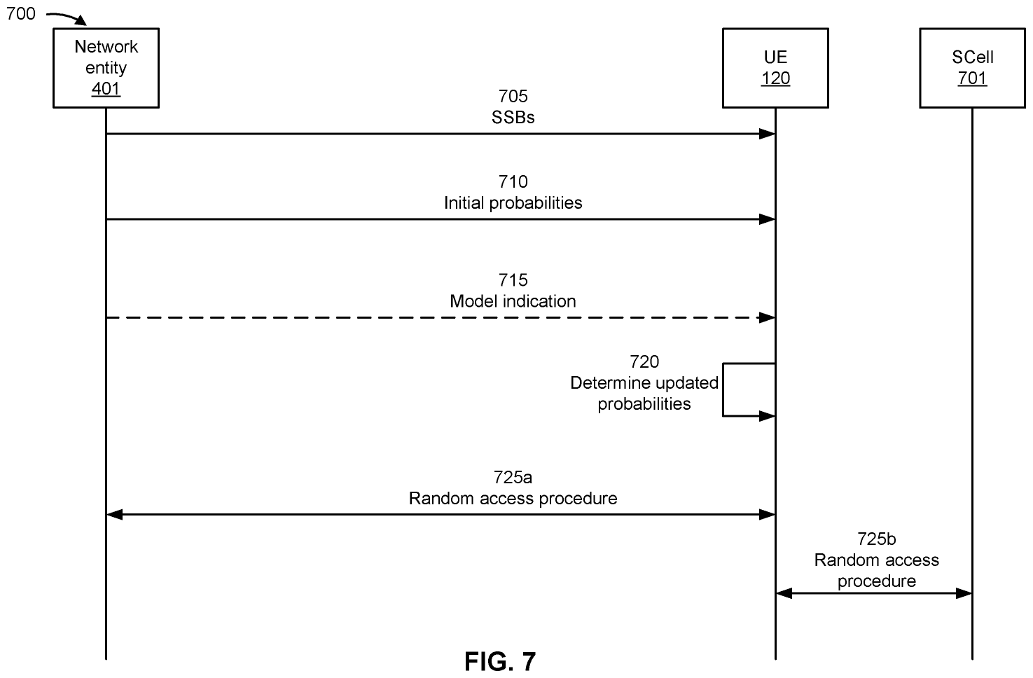

FIG. 7 is a diagram illustrating an example 700 associated with probability-based random access procedures, in accordance with the present disclosure. As shown in FIG. 7, a network entity 401 (e.g., an RU 340 and/or a device controlling the RU 340, such as a CU 310 and/or DU 330) and a UE 120 may communicate with one another (e.g., on a wireless network, such as wireless network 100 of FIG. 1).

As shown by reference number 705, the network entity 401 may transmit (e.g., directly or via an RU 340 controlled by the network entity 401), and the UE 120 may receive, one or more SSBs broadcast by the wireless network (e.g., in which the network entity 401 is included). Accordingly, the UE 120 may select an initial SSB to decode a MIB associated with the network entity 401. Additionally, the UE 120 may perform measurements (e.g., RSRP measurements) of the SSBs broadcast by the wireless network.

As shown by reference number 710, the network entity 401 may transmit (e.g., directly or via an RU 340 controlled by the network entity 401), and the UE 120 may receive, an initial set of probabilities associated with a first set of SSBs (e.g., as described in connection with FIG. 6). For example, the UE 120 may receive the initial set of probabilities in RMSI and/or OSI from the network entity 401.

In some aspects, the initial set of probabilities is cell-common (e.g., across a cell that includes the network entity 401). For example, the initial set of probabilities is the same no matter which SSB the UE 120 uses as the initial SSB (e.g., to decode system information). Accordingly, the UE 120 does not expect different initial sets of probabilities based on which SSB is used to monitor for RMSI and/or OSI. Alternatively, the initial set of probabilities may be specific to the initial SSB. For example, the network entity 401 may include different initial sets of probabilities in different RMSIs and/or OSIs. Accordingly, which initial set of probabilities is received by the UE 120 depends on which SSB is used to monitor for RMSI and/or OSI.

In some aspects, the initial set of probabilities includes quantized values (e.g., rounded to the nearest 5% as shown in example 600 of FIG. 6). Alternatively, the initial set of probabilities includes an ascending order, or a descending order, of probabilities associated with the first set of SSBs. Accordingly, the UE 120 may determine (e.g., based on a preconfigured rule and/or as indicated in the MIB, RMSI, and/or OSI) quantized values associated with the first set of SSBs based on the order (whether ascending or descending). For example, the initial set of probabilities may rank the SSBs in descending order as SSB #1, SSB #3, and SSB #9, such that the UE 120 associates a quantized value of 50% to SSB #1, a quantized value of 30% to SSB #3, and a quantized value of 20% to SSB #9. Other preconfigured associations may be used. Alternatively, the initial set of probabilities includes equal probabilities for SSBs included in the first set. For example, the network entity 401 may indicate the first set of SSBs (e.g., using a bitmap and/or another similar data structure), and the UE 120 may assume that each SSB indicated as included in the first set is associated with an equal probability. In one example, the network entity 401 may indicate that the first set includes SSB #5 and SSB #11, so the UE 120 associates a 50% probability with each of SSB #5 and SSB #11. In another example, the network entity 401 may indicate that the first set includes SSB #0, SSB #5, SSB #9, and SSB #11, so the UE 120 associates a 25% probability with each of SSB #0, SSB #5, SSB #9, and SSB #11.

In some aspects, the network entity 401 may indicate a quantization scheme (e.g., whether the initial set of probabilities includes quantized values, an ascending or descending order, or equal probabilities). For example, the network entity 401 may use the MIB, RMSI, and/or OSI to indicate the quantization scheme. In some aspects, different quantization schemes may be used for different MIBs, RMSIs, and/or OSIs. Accordingly, which quantization scheme is used for the initial set of probabilities may depend on which SSB the UE 120 uses to monitor for RMSI and/or OSI.

In some aspects, as shown by reference number 715, the network entity 401 may transmit (e.g., directly or via an RU 340 controlled by the network entity 401), and the UE 120 may receive, an indication of a model (e.g., model 605 as described in connection with FIG. 6) to use for deriving an updated set of probabilities associated with a second set of SSBs (e.g., as described in connection with reference number 720). For example, the UE 120 may be programmed (and/or otherwise preconfigured) with a set of possible models such that the network entity 401 indicates a selected model to use from the set of possible models. In some aspects, the indication may be cell-common (e.g., across a cell that includes the network entity 401). For example, the selected model may be the same no matter which SSB the UE 120 uses as the initial SSB (e.g., to decode system information). Accordingly, the UE 120 does not expect different models to be selected based on which SSB is used to monitor for RMSI and/or OSI. Alternatively, the indication may be specific to the initial SSB. For example, the network entity 401 may indicate different models to be selected in different RMSIs and/or OSIs. Accordingly, which model is selected depends on which SSB the UE 120 uses to monitor for RMSI and/or OSI.

Alternatively, the UE 120 may be programmed (and/or otherwise preconfigured) with a single model. Accordingly, operations described in connection with reference number 715 may be omitted.

As shown by reference number 720, the UE 120 may determine the updated set of probabilities (e.g., updated set of probabilities 607 as described in connection with FIG. 6) associated with the second set of SSBs (e.g., second set of SSBs 609 as described in connection with FIG. 6). For example, the UE 120 may apply an analytical model or a machine learning model to determine the updated set of probabilities (e.g., as described in connection with model 605 of FIG. 6).

Accordingly, as shown by reference number 725a, the UE 120 may perform, with the network entity 401 (e.g., directly or via an RU 340 controlled by the network entity 401), a random access procedure with an SSB selected from the second set of SSBs. Alternatively, and as shown by reference number 725b, the UE 120 may perform the random access procedure, with an SSB selected from the second set of SSBs, with an SCell 701. Accordingly, the network entity 401 may, during operations described in connection with reference numbers 705, 710, and 715, use RRC messages rather than the MIB, RMSI, and/or OSI.

By using techniques as described in connection with FIG. 7, the UE 120 applies probabilities to select the SSB to use for the random access procedure. As a result, latency before the UE 120 establishes a RACH with the network entity 401 is reduced. Additionally, the UE 120 avoids selecting an SSB that is less likely to result in a successful random access procedure, which conserves power and processing resources that otherwise would have been consumed by one or more failed random access procedures.

As indicated above, FIG. 7 is provided as an example. Other examples may differ from what is described with respect to FIG. 7.

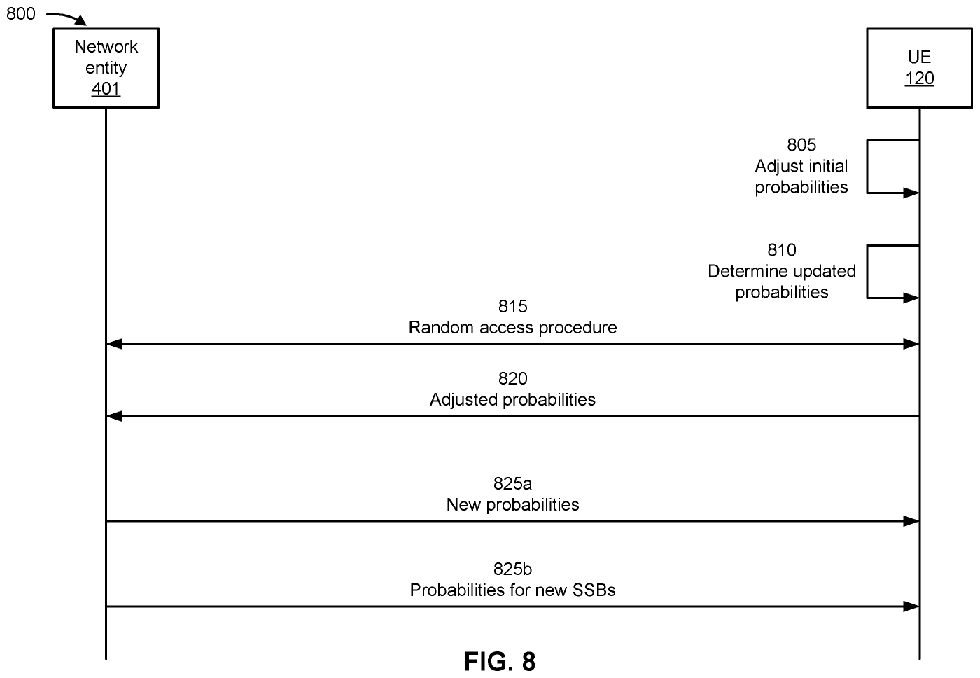

FIG. 8 is a diagram illustrating an example 800 associated with updating probabilities for random access procedures, in accordance with the present disclosure. As shown in FIG. 8, a network entity 401 (e.g., an RU 340 and/or a device controlling the RU 340, such as a CU 310 and/or DU 330) and a UE 120 may communicate with one another (e.g., on a wireless network, such as wireless network 100 of FIG. 1).

As shown by reference number 805, the UE 120 may update an initial set of probabilities associated with a first set of SSBs. For example, the UE 120 may have received the initial set of probabilities as described in connection with reference number 710 of FIG. 7. In some aspects, the UE 120 may update the initial set of probabilities based on one or more interference measurements associated with one or more SSBs in the first set. For example, the UE 120 may determine an RSRP associated with the RO(s) and/or the random access preamble(s) corresponding to the SSB(s). Accordingly, the UE 120 may reduce one or more first probabilities, in the initial set and associated with one or more first SSBs in the first set, when one or more interference measurements associated with the first SSB(s) satisfy an interference threshold. Similarly, the UE 120 may increase one or more second probabilities, in the initial set and associated with one or more second SSBs in the first set, when one or more interference measurements associated with the second SSB(s) fail to satisfy the interference threshold.

Additionally, or alternatively, the UE 120 may update the initial set of probabilities based on a location associated with the UE 120. For example, the UE 120 may use a global navigation satellite system (GNSS) to determine the location of the UE 120 and update the initial set of probabilities based on the location. Accordingly, the UE 120 may reduce one or more first probabilities, in the initial set and associated with one or more first SSBs in the first set, when the location is associated with poor conditions (e.g., blockages and/or other interference) for the first SSB(s). Similarly, the UE 120 may increase one or more second probabilities, in the initial set and associated with one or more second SSBs in the first set, when the location is associated with good conditions (e.g., clear line-of-sight) for the second SSB(s).

When determining which SSB to use for SCG configuration, the UE 120 may use a location from an LTE positioning protocol (LPP) or a location management function (LMF). Accordingly, the location associated with the UE 120 may be provided by a core network supporting the network entity 401.

The UE 120 may update the initial set of probabilities using a formula (e.g., a table or another formula that outputs adjustments to the initial set of probabilities based on the interference measurements and/or the location). Additionally, or alternatively, the UE 120 may update the initial set of probabilities using a machine learning model (e.g., a neural network that adjusts the initial set of probabilities based on inputs). For initial access, the formula and/or the machine learning model may be programmed (and/or otherwise preconfigured) into a memory of the UE 120. However, when determining which SSB to use for SCG configuration, the UE 120 may receive an indication of (or a payload including) a formula and/or a machine learning model to apply from the network entity 401.

The machine learning model may accept, as input, one or more of: the interference measurement(s) performed by the UE 120, if performed; the location associated with the UE 120, if determined; an index associated with the initial SSB used by the UE 120; the initial set of probabilities; or measurements (e.g., RSRPs) associated with the first set of SSBs. Accordingly, the machine learning model may output the initial set of probabilities, as adjusted.

In some aspects, the formula and/or the machine learning model may be cell-common (e.g., across a cell including the network entity 401). For example, the formula and/or the machine learning model may apply no matter which SSB the UE 120 uses as an initial SSB (e.g., to decode system information). Alternatively, the formula and/or the machine learning model may be selected based on which SSB the UE 120 uses as the initial SSB (e.g., to decode system information).

Accordingly, as shown by reference number 810, the UE 120 may determine an updated set of probabilities (e.g., updated set of probabilities 607 as described in connection with FIG. 6) associated with a second set of SSBs (e.g., second set of SSBs 609 as described in connection with FIG. 6). For example, the UE 120 may use the initial set of probabilities, as adjusted, to determine the updated set of probabilities (e.g., as described in connection with model 605 of FIG. 6).

Accordingly, as shown by reference number 815, the UE 120 may establish an RRC connection with the network entity 401 by performing (e.g., directly or via an RU 340 controlled by the network entity 401) a random access procedure with an SSB selected from the second set of SSBs. Upon establishing an RRC connection with the network entity 401, the UE 120 may transmit, and the network entity may receive (e.g., directly or via an RU 340 controlled by the network entity 401), the adjusted set of probabilities based on the initial set of probabilities, as shown by reference number 820. For example, the UE 120 may use RRC messages (and/or other layer 3 (L3) signaling) to indicate the adjusted set of probabilities.

Additionally, or alternatively, and as shown by reference number 825a, the network entity may transmit (e.g., directly or via an RU 340 controlled by the network entity 401), and the UE 120 may receive, a new initial set of probabilities after performing the random access procedure. For example, the network entity 401 may update the initial set of probabilities (e.g., based on adjusted sets of probabilities received from the UE 120 and/or another UE in the cell) and indicate the update to the UE 120. The new initial set of probabilities may be indicated in updated RMSI and/or OSI from the network entity 401. Additionally, or alternatively, the new initial set of probabilities may be indicated in a cell-common paging message to the UE 120 (and other UEs within the cell). Additionally, or alternatively, the network entity 401 may indicate the new initial set of probabilities in a broadcast RRC message. For example, the network entity 401 may transmit (e.g., directly or via an RU 340 controlled by the network entity 401) group-common DCI to the UE 120 (and other UEs within the cell) to schedule a group-common PDSCH carrying the broadcast RRC message. Additionally, or alternatively, the network entity 401 may indicate the new initial set of probabilities in a UE-specific RRC message. For example, the network entity 401 may transmit (e.g., directly or via an RU 340 controlled by the network entity 401) DCI to the UE 120 to schedule a UE-specific PDSCH carrying the UE-specific RRC message.

Additionally, or alternatively, and as shown by reference number 825b, the network entity 401 may transmit (e.g., directly or via an RU 340 controlled by the network entity 401), and the UE 120 may receive, one or more initial sets of probabilities associated with different initial SSBs. For example, the initial set of probabilities may be specific to the initial SSB used by the UE 120, so the network entity 401 may indicate other initial sets of probabilities associated with other initial SSBs. The UE 120 may use the other initial sets of probabilities for additional RACH procedures and/or beam failure recovery (BFR) in which the UE 120 may select a different initial SSB.

By using techniques as described in connection with FIG. 8, the network entity 401 updates initial probabilities used to select SSBs for random access procedures. As a result, accuracy of the initial probabilities is increased, which increases likelihood of successful random access procedures in the cell, which conserves power and processing resources that otherwise would have been consumed by one or more failed random access procedures.

As indicated above, FIG. 8 is provided as an example. Other examples may differ from what is described with respect to FIG. 8.

FIG. 9 is a diagram illustrating an example 900 associated with concurrent and timer-based random access procedures, in accordance with the present disclosure. As shown in FIG. 9, a network entity 401 (e.g., an RU 340 and/or a device controlling the RU 340, such as a CU 310 and/or DU 330) and a UE 120 may communicate with one another (e.g., on a wireless network, such as wireless network 100 of FIG. 1).

As shown by reference number 905, the UE 120 may initiate a timer at a beginning of an RO. For example, the timer may have a value that is programmed (and/or otherwise preconfigured) in a memory of the UE 120. Additionally, or alternatively, the timer may have a value indicated by the network entity 401 in RMSI and/or OSI.

As shown by reference number 910a, the UE 120 may transmit, and the network entity 401 may receive (e.g., directly or via an RU 340 controlled by the network entity 401), an initial random access message using an SSB selected from a second set of SSBs (e.g., as described in connection with FIGS. 6 and 7). In some aspects, the initial random access message is transmitted before expiry of the timer associated with the RO for the initial random access message.

Alternatively, as shown by reference number 910b, the UE 120 may further transmit, and the network entity 401 may receive (e.g., directly or via an RU 340 controlled by the network entity 401), another initial random access message using another SSB selected from the second set of SSBs (e.g., as described in connection with FIGS. 6 and 7). Accordingly, the UE 120 may transmit a plurality of initial random access messages concurrently in order to increase chances of a successful random access procedure with the network entity 401. The UE 120 may transmit a quantity of initial random access messages that satisfies a threshold (e.g., represented by K). The threshold K may be programmed (and/or otherwise preconfigured) in a memory of the UE 120. Additionally, or alternatively, the threshold K may be indicated by the network entity 401 in RMSI and/or OSI.

As shown by reference number 915, the network entity 401 may transmit (e.g., directly or via an RU 340 controlled by the network entity 401), and the UE 120 may receive, a random access response. In aspects where the UE 120 uses the timer, the network entity 401 may transmit the random access response for the initial random access message. In aspects where the UE 120 transmits a plurality of initial random access messages concurrently, the network entity 401 may transmit one random access response to a selected one of the plurality of initial random access messages or may transmit a plurality of random access responses. The random access response(s) may be transmitted in a single RAR window associated with the second set of SSBs. Accordingly, the UE 120 conserves power and processing resources by monitoring only the single RAR window after transmitting the plurality of initial random access messages.

Therefore, as shown by reference number 920, the UE 120 may transmit, and the network entity 401 may receive (e.g., directly or via an RU 340 controlled by the network entity 401) a msg3 (e.g., when using 4-step random access as described in connection with FIG. 4) or an uplink message (UL msg) (e.g., when using 2-step random access as described in connection with FIG. 5). In aspects where the network entity 401 transmits a plurality of random access responses, the network entity 401 may use blind decoding (e.g., directly or by instructing an RU 340 controlled by the network entity 401 to use blind decoding) to receive a subsequent message (the msg3 or the UL msg) from the UE 120, as shown by reference number 925.

As indicated above, FIG. 9 is provided as an example. Other examples may differ from what is described with respect to FIG. 9.

FIG. 10 is a diagram illustrating an example process 1000 performed, for example, by a UE, in accordance with the present disclosure. Example process 1000 is an example where the UE (e.g., UE 120 and/or apparatus 1200 of FIG. 12) performs operations associated with probability-based random access procedures.

As shown in FIG. 10, in some aspects, process 1000 may include receiving an initial set of probabilities, associated with a first set of SSBs, indicating chances of using SSBs within the first set for a random access procedure (block 1010). For example, the UE (e.g., using communication manager 140 and/or reception component 1202, depicted in FIG. 12) may receive an initial set of probabilities, associated with a first set of SSBs, indicating chances of using SSBs within the first set for a random access procedure, as described herein.

As further shown in FIG. 10, in some aspects, process 1000 may include determining an updated set of probabilities, associated with a second set of SSBs, based on the initial set of probabilities and indicating chances of using SSBs within the second set for the random access procedure (block 1020). For example, the UE (e.g., using communication manager 140 and/or determination component 1208, depicted in FIG. 12) may determine an updated set of probabilities, associated with a second set of SSBs, based on the initial set of probabilities and indicating chances of using SSBs within the second set for the random access procedure, as described herein.

As further shown in FIG. 10, in some aspects, process 1000 may include performing the random access procedure with an SSB selected from the second set of SSBs (block 1030). For example, the UE (e.g., using communication manager 140, reception component 1202, and/or transmission component 1204, depicted in FIG. 12) may perform the random access procedure with an SSB selected from the second set of SSBs, as described herein.

Process 1000 may include additional aspects, such as any single aspect or any combination of aspects described below and/or in connection with one or more other processes described elsewhere herein.

In a first aspect, the set of probabilities are included in RMSI, OSI, or a combination thereof.

In a second aspect, alone or in combination with the first aspect, process 1000 further includes attempting a previous random access procedure (e.g., using communication manager 140, reception component 1202, and/or transmission component 1204)) using an initial SSB selected based on a signal strength associated with the initial SSB, such that the first set of SSBs does not include the initial SSB.

In a third aspect, alone or in combination with one or more of the first and second aspects, the second set of SSBs is the first set of SSBs or is a subset of the first set of SSBs.

In a fourth aspect, alone or in combination with one or more of the first through third aspects, the second set of SSBs are indicated in RMSI, OSI, or a combination thereof.

In a fifth aspect, alone or in combination with one or more of the first through fourth aspects, the updated set of probabilities is determined using an analytical model.

In a sixth aspect, alone or in combination with one or more of the first through fifth aspects, the updated set of probabilities is determined using a machine learning model.

In a seventh aspect, alone or in combination with one or more of the first through sixth aspects, the machine learning model accepts, as input, at least one of: an index associated with an initial SSB associated with a highest signal strength measurement, the initial set of probabilities, measurements of signal strength associated with the first set of SSBs, measurements of signal strength associated with the second set of SSBs, measurements of signal strength associated with one or more SSBs not included in the first set or the second set, or one or more indices associated with SSBs used in one or more unsuccessful random access procedures.

In an eighth aspect, alone or in combination with one or more of the first through seventh aspects, the machine learning model outputs an indication of the second set of SSBs, an indication of the updated set of probabilities, or a combination thereof.

In a ninth aspect, alone or in combination with one or more of the first through eighth aspects, process 1000 further includes selecting (e.g., using communication manager 140 and/or selection component 1210, depicted in FIG. 12) the machine learning model from a set of possible machine learning models based on an indication in RMSI, OSI, or a combination thereof.

In a tenth aspect, alone or in combination with one or more of the first through ninth aspects, an initial SSB is selected during initial access from all SSBs broadcast, and the machine learning model is applied for all initial SSBs.

In an eleventh aspect, alone or in combination with one or more of the first through tenth aspects, the machine learning model is indicated by system information associated with an initial SSB, wherein system information associated with different initial SSBs indicates different machine learning models.

In a twelfth aspect, alone or in combination with one or more of the first through eleventh aspects, an initial SSB is selected during initial access from all SSBs broadcast, and the initial set of probabilities is the same for all initial SSBs.

In a thirteenth aspect, alone or in combination with one or more of the first through twelfth aspects, the initial set of probabilities is indicated by system information associated with an initial SSB, wherein system information associated with different initial SSBs indicates different initial sets of probabilities.

In a fourteenth aspect, alone or in combination with one or more of the first through thirteenth aspects, the initial set of probabilities includes quantized values associated with the first set of SSBs.

In a fifteenth aspect, alone or in combination with one or more of the first through fourteenth aspects, the initial set of probabilities includes an ascending order, or a descending order, of probabilities associated with the first set of SSBs.

In a sixteenth aspect, alone or in combination with one or more of the first through fifteenth aspects, process 1000 further includes determining (e.g., using communication manager 140 and/or determination component 1208) quantized values associated with the first set of SSBs based on the ascending order or the descending order.

In a seventeenth aspect, alone or in combination with one or more of the first through sixteenth aspects, the initial set of probabilities includes equal probabilities for SSBs included in the first set.

In an eighteenth aspect, alone or in combination with one or more of the first through seventeenth aspects, process 1000 further includes receiving (e.g., using communication manager 140 and/or reception component 1202) an indication of whether the initial set of probabilities includes quantized values, an ascending or descending order, or equal probabilities in at least one of a MIB, RMSI, or OSI.

In a nineteenth aspect, alone or in combination with one or more of the first through eighteenth aspects, an initial SSB is selected during initial access from all SSBs broadcast, and the indication is the same for all initial SSBs.

In a twentieth aspect, alone or in combination with one or more of the first through nineteenth aspects, the indication is included in system information associated with an initial SSB, wherein system information associated with different initial SSBs includes different indications.

In a twenty-first aspect, alone or in combination with one or more of the first through twentieth aspects, process 1000 further includes adjusting (e.g., using communication manager 140 and/or adjustment component 1212, depicted in FIG. 12) the initial set of probabilities based on an interference measurement, a location associated with the UE, or a combination thereof, such that the updated set of probabilities is based on the initial set of probabilities after the adjusting.

In a twenty-second aspect, alone or in combination with one or more of the first through twenty-first aspects, the interference measurement is associated with one or more random access preambles associated with at least one SSB included in the first set of SSBs.

In a twenty-third aspect, alone or in combination with one or more of the first through twenty-second aspects, the initial set of probabilities are adjusted using a formula indicated in RMSI, OSI, or a combination thereof.

In a twenty-fourth aspect, alone or in combination with one or more of the first through twenty-third aspects, the initial set of probabilities are adjusted using a machine learning model.

In a twenty-fifth aspect, alone or in combination with one or more of the first through twenty-fourth aspects, process 1000 further includes selecting (e.g., using communication manager 140 and/or selection component 1210) the machine learning model from a set of possible machine learning models based on an indication in RMSI, OSI, or a combination thereof.

In a twenty-sixth aspect, alone or in combination with one or more of the first through twenty-fifth aspects, the machine learning model accepts, as input, at least one of: the interference measurement, the location associated with the UE, an index associated with an initial SSB associated with a highest signal strength measurement, the initial set of probabilities, or measurements of signal strength associated with the first set of SSBs.

In a twenty-seventh aspect, alone or in combination with one or more of the first through twenty-sixth aspects, the machine learning model outputs the initial set of probabilities after adjusting.

In a twenty-eighth aspect, alone or in combination with one or more of the first through twenty-seventh aspects, the first set of SSBs and the second set of SSBs are associated with a secondary serving cell within an SCG, and the initial set of probabilities are indicated in an RRC message associated with the secondary serving cell.

In a twenty-ninth aspect, alone or in combination with one or more of the first through twenty-eighth aspects, performing the random access procedure includes transmitting (e.g., using communication manager 140 and/or transmission component 1204), concurrently, a plurality of initial random access messages using the SSB, and at least one additional SSB, selected from the second set of SSBs.

In a thirtieth aspect, alone or in combination with one or more of the first through twenty-ninth aspects, a quantity of the plurality of initial random access messages is indicated in RMSI, OSI, or a combination thereof.

In a thirty-first aspect, alone or in combination with one or more of the first through thirtieth aspects, process 1000 further includes receiving (e.g., using communication manager 140 and/or reception component 1202) an RAR within a single RAR window associated with the SSB, and the at least one additional SSB, selected from the second set of SSBs.

In a thirty-second aspect, alone or in combination with one or more of the first through thirty-first aspects, performing the random access procedure includes transmitting (e.g., using communication manager 140 and/or transmission component 1204) an initial random access message using the SSB selected from the second set of SSBs according to a timer starting at a random access occasion associated with the SSB.

In a thirty-third aspect, alone or in combination with one or more of the first through thirty-second aspects, the timer is indicated in RMSI, OSI, or a combination thereof.

In a thirty-fourth aspect, alone or in combination with one or more of the first through thirty-third aspects, process 1000 further includes transmitting (e.g., using communication manager 140 and/or transmission component 1204) an adjusted set of probabilities based on the initial set of probabilities after performing the random access procedure.

In a thirty-fifth aspect, alone or in combination with one or more of the first through thirty-fourth aspects, process 1000 further includes receiving (e.g., using communication manager 140 and/or reception component 1202) one or more initial sets of probabilities associated with different initial SSBs.

In a thirty-sixth aspect, alone or in combination with one or more of the first through thirty-fifth aspects, process 1000 further includes receiving (e.g., using communication manager 140 and/or reception component 1202) a new initial set of probabilities after performing the random access procedure.

In a thirty-seventh aspect, alone or in combination with one or more of the first through thirty-sixth aspects, the new initial set of probabilities are included in RMSI, OSI, a cell-common paging message, or a combination thereof.

In a thirty-eighth aspect, alone or in combination with one or more of the first through thirty-seventh aspects, the new initial set of probabilities are included in a broadcast RRC message.

In a thirty-ninth aspect, alone or in combination with one or more of the first through thirty-eighth aspects, the new initial set of probabilities are included in a UE-specific RRC message.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network entity, in accordance with the present disclosure. Example process 1100 is an example where the network entity (e.g., network entity 401 and/or apparatus 1300 of FIG. 13) performs operations associated with probability-based random access procedures.

As shown in FIG. 11, in some aspects, process 1100 may include transmitting an initial set of probabilities, associated with a first set of SSBs, indicating chances of using SSBs within the first set for a random access procedure (block 1110). For example, the network entity (e.g., using communication manager 150 and/or transmission component 1304, depicted in FIG. 13) may transmit an initial set of probabilities, associated with a first set of SSBs, indicating chances of using SSBs within the first set for a random access procedure, as described herein.

As further shown in FIG. 11, in some aspects, process 1100 may include performing, with a UE (e.g., UE 120 and/or apparatus 1200 of FIG. 12), the random access procedure with an SSB that was selected based at least in part on the initial set of probabilities (block 1120). For example, the network entity (e.g., using communication manager 150, transmission component 1304, and/or reception component 1302, depicted in FIG. 13) may perform, with a UE, the random access procedure with an SSB that was selected based at least in part on the initial set of probabilities, as described herein.

Process 1100 may include additional aspects, such as any single aspect or any combination of aspects described below and/or in connection with one or more other processes described elsewhere herein.

In a first aspect, the set of probabilities are included in RMSI, OSI, or a combination thereof.

In a second aspect, alone or in combination with the first aspect, process 1100 further includes transmitting (e.g., using communication manager 150 and/or transmission component 1304) an indication of a second set of SSBs, where the SSB is selected from the second set of SSBs.

In a third aspect, alone or in combination with one or more of the first and second aspects, the second set of SSBs are indicated in RMSI, OSI, or a combination thereof.

In a fourth aspect, alone or in combination with one or more of the first through third aspects, process 1100 further includes transmitting (e.g., using communication manager 150 and/or transmission component 1304) an indication of a machine learning model, from a set of possible machine learning models, in RMSI, OSI, or a combination thereof, where the SSB is selected based at least in part on the machine learning model.

In a fifth aspect, alone or in combination with one or more of the first through fourth aspects, an initial SSB is selected during initial access from all SSBs broadcast, and the machine learning model is applied for all initial SSBs.

In a sixth aspect, alone or in combination with one or more of the first through fifth aspects, the machine learning model is indicated by system information associated with an initial SSB, wherein system information associated with different initial SSBs indicates different machine learning models.

In a seventh aspect, alone or in combination with one or more of the first through sixth aspects, an initial SSB is selected during initial access from all SSBs broadcast, and the initial set of probabilities is the same for all initial SSBs.

In an eighth aspect, alone or in combination with one or more of the first through seventh aspects, the initial set of probabilities is indicated by system information associated with an initial SSB, wherein system information associated with different initial SSBs indicates different initial sets of probabilities.

In a ninth aspect, alone or in combination with one or more of the first through eighth aspects, the initial set of probabilities includes quantized values associated with the first set of SSBs.

In a tenth aspect, alone or in combination with one or more of the first through ninth aspects, the initial set of probabilities includes an ascending order, or a descending order, of probabilities associated with the first set of SSBs.

In an eleventh aspect, alone or in combination with one or more of the first through tenth aspects, the initial set of probabilities includes equal probabilities for SSBs included in the first set.

In a twelfth aspect, alone or in combination with one or more of the first through eleventh aspects, process 1100 further includes transmitting (e.g., using communication manager 150 and/or transmission component 1304) an indication of whether the initial set of probabilities includes quantized values, an ascending or descending order, or equal probabilities in at least one of a MIB, RMSI, or OSI.

In a thirteenth aspect, alone or in combination with one or more of the first through twelfth aspects, an initial SSB is selected during initial access from all SSBs broadcast, and the indication is the same for all initial SSBs.

In a fourteenth aspect, alone or in combination with one or more of the first through thirteenth aspects, the indication is included in system information associated with an initial SSB, wherein system information associated with different initial SSBs includes different indications.

In a fifteenth aspect, alone or in combination with one or more of the first through fourteenth aspects, process 1100 further includes transmitting (e.g., using communication manager 150 and/or transmission component 1304) an indication of a formula in RMSI, OSI, or a combination thereof, where the initial set of probabilities are adjusted based on the formula.

In a sixteenth aspect, alone or in combination with one or more of the first through fifteenth aspects, process 1100 further includes transmitting (e.g., using communication manager 150 and/or transmission component 1304) an indication of a machine learning model, from a set of possible machine learning models, in RMSI, OSI, or a combination thereof, where the initial set of probabilities are adjusted based on the machine learning model.

In a seventeenth aspect, alone or in combination with one or more of the first through sixteenth aspects, the first set of SSBs are associated with a secondary serving cell within an SCG, and the initial set of probabilities are indicated in an RRC message associated with the secondary serving cell.

In an eighteenth aspect, alone or in combination with one or more of the first through seventeenth aspects, performing the random access procedure includes receiving (e.g., using communication manager 150 and/or reception component 1302), concurrently, a plurality of initial random access messages using the SSB, and at least one additional SSB, that were selected based at least in part on the initial set of probabilities.

In a nineteenth aspect, alone or in combination with one or more of the first through eighteenth aspects, a quantity of the plurality of initial random access messages is indicated in RMSI, OSI, or a combination thereof.

In a twentieth aspect, alone or in combination with one or more of the first through nineteenth aspects, process 1100 further includes transmitting (e.g., using communication manager 150 and/or transmission component 1304) an RAR within a single RAR window associated with the SSB, and the at least one additional SSB, that were selected based at least in part on the initial set of probabilities.

In a twenty-first aspect, alone or in combination with one or more of the first through twentieth aspects, process 1100 includes transmitting (e.g., using communication manager 150 and/or transmission component 1304) a plurality of RARs, and receiving (e.g., using communication manager 150 and/or reception component 1302), using blind decoding, a subsequent message in response to one RAR of the plurality of RARs.

In a twenty-second aspect, alone or in combination with one or more of the first through twenty-first aspects, performing the random access procedure includes receiving (e.g., using communication manager 150 and/or reception component 1302) an initial random access message using the SSB that was selected based at least in part on the initial set of probabilities according to a timer starting at a random access occasion associated with the SSB.

In a twenty-third aspect, alone or in combination with one or more of the first through twenty-second aspects, the timer is indicated in RMSI, OSI, or a combination thereof.

In a twenty-fourth aspect, alone or in combination with one or more of the first through twenty-third aspects, process 1100 further includes receiving (e.g., using communication manager 150 and/or reception component 1302) an adjusted set of probabilities based on the initial set of probabilities after performing the random access procedure.

In a twenty-fifth aspect, alone or in combination with one or more of the first through twenty-fourth aspects, process 1100 further includes transmitting (e.g., using communication manager 150 and/or transmission component 1304) one or more initial sets of probabilities associated with different initial SSBs.

In a twenty-sixth aspect, alone or in combination with one or more of the first through twenty-fifth aspects, process 1100 further includes transmitting (e.g., using communication manager 150 and/or transmission component 1304) a new initial set of probabilities after performing the random access procedure.

In a twenty-seventh aspect, alone or in combination with one or more of the first through twenty-sixth aspects, the new initial set of probabilities are included in RMSI, OSI, a cell-common paging message, or a combination thereof.

In a twenty-eighth aspect, alone or in combination with one or more of the first through twenty-seventh aspects, the new initial set of probabilities are included in a broadcast RRC message.

In a twenty-ninth aspect, alone or in combination with one or more of the first through twenty-eighth aspects, the new initial set of probabilities are included in a UE-specific RRC message.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include one or more of a determination component 1208, a selection component 1210, and/or an adjustment component 1212, among other examples.

In some aspects, the apparatus 1200 may be configured to perform one or more operations described herein in connection with FIGS. 6-9. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

In some aspects, the reception component 1202 may receive (e.g., from the apparatus 1206, such as a network entity) an initial set of probabilities, associated with a first set of SSBs, indicating chances of using SSBs within the first set for a random access procedure. The determination component 1208 may determine an updated set of probabilities, associated with a second set of SSBs, based on the initial set of probabilities and indicating chances of using SSBs within the second set for the random access procedure. The determination component 1208 may include a MIMO detector, a receive processor, a transmit MIMO processor, a transmit processor, a controller/processor, a memory, or a combination thereof, of the UE described in connection with FIG. 2. Accordingly, the transmission component 1204 and the reception component 1202 may perform (e.g., with the apparatus 1206) the random access procedure with an SSB selected from the second set of SSBs.

In some aspects, the transmission component 1204 and the reception component 1202 may attempt a previous random access procedure using an initial SSB selected based on a signal strength associated with the initial SSB. Accordingly, the first set of SSBs may not include the initial SSB.

In some aspects, the selection component 1210 may select a machine learning model from a set of possible machine learning models to use for determining the updated set of probabilities (e.g., based on an indication in RMSI, OSI, or a combination thereof from the apparatus 1206). The selection component 1210 may include a controller/processor, a memory, or a combination thereof, of the UE described in connection with FIG. 2.

In some aspects, the determination component 1208 may determine quantized values associated with the first set of SSBs based on an ascending order or a descending order. Additionally, or alternatively, the reception component 1202 may receive (e.g., from the apparatus 1206) an indication of whether the initial set of probabilities includes quantized values, an ascending or descending order, or equal probabilities in at least one of a MIB, RMSI, or OSI.

In some aspects, the adjustment component 1212 may adjust the initial set of probabilities based on an interference measurement, a location associated with the apparatus 1200, or a combination thereof. The adjustment component 1212 may include a MIMO detector, a receive processor, a transmit MIMO processor, a transmit processor, a controller/processor, a memory, or a combination thereof, of the UE described in connection with FIG. 2. Accordingly, the updated set of probabilities is based on the initial set of probabilities after the adjusting. In some aspects, the selection component 1210 may select a machine learning model to use for adjusting from a set of possible machine learning models (e.g., based on an indication in RMSI, OSI, or a combination thereof from the apparatus 1206).

In some aspects, the reception component 1202 may receive (e.g., from the apparatus 1206) an RAR within a single RAR window associated with the SSB, and at least one additional SSB, selected from the second set of SSBs. After the random access procedure, the transmission component 1204 may transmit (e.g., to the apparatus 1206) an adjusted set of probabilities based on the initial set of probabilities. Additionally, or alternatively, the reception component 1202 may receive (e.g., from the apparatus 1206) one or more initial sets of probabilities associated with different initial SSBs. Additionally, or alternatively, the reception component 1202 may receive (e.g., from the apparatus 1206) a new initial set of probabilities.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a network entity, or a network entity may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 150. The communication manager 150 may include an updating component 1308, among other examples.

In some aspects, the apparatus 1300 may be configured to perform one or more operations described herein in connection with FIGS. 6-9. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the base station described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the base station described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the base station described in connection with FIG. 2. In some aspects, the transmission component 1304 may be co-located with the reception component 1302 in a transceiver.

In some aspects, the transmission component 1304 may transmit (e.g., to the apparatus 1306, such as a UE) an initial set of probabilities, associated with a first set of SSBs, indicating chances of using SSBs within the first set for a random access procedure. Accordingly, the transmission component 1304 and the reception component 1302 may perform (e.g., with the apparatus 1306) the random access procedure with an SSB that was selected (e.g., by the apparatus 1306) based at least in part on the initial set of probabilities.

In some aspects, the transmission component 1304 may transmit (e.g., to the apparatus 1306) an indication of a second set of SSBs. Accordingly, the SSB may be selected from the second set of SSBs. In some aspects, the transmission component 1304 may transmit (e.g., to the apparatus 1306 in RMSI, OSI, or a combination thereof) an indication of a machine learning model, from a set of possible machine learning models, such that the SSB is selected (e.g., by the apparatus 1306) based at least in part on the machine learning model.

In some aspects, the transmission component 1304 may transmit (e.g., to the apparatus 1306 in at least one of a MIB, RMSI, or OSI) an indication of whether the initial set of probabilities includes quantized values, an ascending or descending order, or equal probabilities.

In some aspects, the transmission component 1304 may transmit (e.g., to the apparatus 1306 in RMSI, OSI, or a combination thereof) an indication of a formula such that the initial set of probabilities are adjusted (e.g., by the apparatus 1306) based on the formula. Alternatively, the transmission component 1304 may transmit (e.g., to the apparatus 1306 in RMSI, OSI, or a combination thereof) an indication of a machine learning model, from a set of possible machine learning models, such that the initial set of probabilities are adjusted (e.g., by the apparatus 1306) based on the machine learning model.

In some aspects, the transmission component 1304 may transmit an RAR (e.g., to the apparatus 1306) within a single RAR window associated with the SSB, and at least one additional SSB, that were selected (e.g., by the apparatus 1306) based at least in part on the initial set of probabilities. Additionally, or alternatively, the transmission component 1304 may transmit (e.g., to the apparatus 1306) a plurality of RARs. Accordingly, the reception component 1302 may receive (e.g., from the apparatus 1306), using blind decoding, a subsequent message in response to one RAR of the plurality of RARs.

After performing the random access procedure, the reception component 1302 may receive (e.g., from the apparatus 1306 and/or from one or more additional UEs) an adjusted set of probabilities based on the initial set of probabilities. Additionally, or alternatively, the transmission component 1304 may transmit (e.g., to the apparatus 1306) one or more initial sets of probabilities associated with different initial SSBs. Additionally, or alternatively, the transmission component 1304 may transmit (e.g., to the apparatus 1306) a new initial set of probabilities. For example, the updating component 1308 may calculate the new initial set of probabilities based on adjusted sets of probabilities received from the apparatus 1306 and/or from one or more additional UEs. The updating component 1308 may include a controller/processor, a memory, or a combination thereof, of the base station described in connection with FIG. 2.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving an initial set of probabilities, associated with a first set of synchronization signal blocks (SSBs), indicating chances of using SSBs within the first set for a random access procedure; determining an updated set of probabilities, associated with a second set of SSBs, based on the initial set of probabilities and indicating chances of using SSBs within the second set for the random access procedure; and performing the random access procedure with an SSB selected from the second set of SSBs.

Aspect 2: The method of Aspect 1, wherein the set of probabilities are included in remaining minimum system information (RMSI), other system information (OSI), or a combination thereof.

Aspect 3: The method of any of Aspects 1 through 2, further comprising: attempting a previous random access procedure using an initial SSB selected based on a signal strength associated with the initial SSB, wherein the first set of SSBs does not include the initial SSB.

Aspect 4: The method of any of Aspects 1 through 3, wherein the second set of SSBs is the first set of SSBs or is a subset of the first set of SSBs.

Aspect 5: The method of any of Aspects 1 through 4, wherein the second set of SSBs are indicated in remaining minimum system information (RMSI), other system information (OSI), or a combination thereof.

Aspect 6: The method of any of Aspects 1 through 5, wherein the updated set of probabilities is determined using an analytical model.

Aspect 7: The method of any of Aspects 1 through 6, wherein the updated set of probabilities is determined using a machine learning model.

Aspect 8: The method of Aspect 7, wherein the machine learning model accepts, as input, at least one of: an index associated with an initial SSB associated with a highest signal strength measurement; the initial set of probabilities; measurements of signal strength associated with the first set of SSBs; measurements of signal strength associated with the second set of SSBs; measurements of signal strength associated with one or more SSBs not included in the first set or the second set; or one or more indices associated with SSBs used in one or more unsuccessful random access procedures.

Aspect 9: The method of any of Aspects 7 through 8, wherein the machine learning model outputs an indication of the second set of SSBs, an indication of the updated set of probabilities, or a combination thereof.

Aspect 10: The method of any of Aspects 7 through 9, further comprising: selecting the machine learning model from a set of possible machine learning models based on an indication in remaining minimum system information (RMSI), other system information (OSI), or a combination thereof.

Aspect 11: The method of any of Aspects 7 through 10, wherein an initial SSB is selected during initial access from all SSBs broadcast, and the machine learning model is applied for all initial SSBs.

Aspect 12: The method of any of Aspects 7 through 10, wherein the machine learning model is indicated by system information associated with an initial SSB, wherein system information associated with different initial SSBs indicates different machine learning models.

Aspect 13: The method of any of Aspects 1 through 12, wherein an initial SSB is selected during initial access from all SSBs broadcast, and the initial set of probabilities is the same for all initial SSBs.

Aspect 14: The method of any of Aspects 1 through 12, wherein the initial set of probabilities is indicated by system information associated with an initial SSB, wherein system information associated with different initial SSBs indicates different initial sets of probabilities.

Aspect 15: The method of any of Aspects 1 through 14, wherein the initial set of probabilities includes quantized values associated with the first set of SSBs.

Aspect 16: The method of any of Aspects 1 through 14, wherein the initial set of probabilities includes an ascending order, or a descending order, of probabilities associated with the first set of SSBs.

Aspect 17: The method of Aspect 16, further comprising: determining quantized values associated with the first set of SSBs based on the ascending order or the descending order.

Aspect 18: The method of any of Aspects 1 through 14, wherein the initial set of probabilities includes equal probabilities for SSBs included in the first set.

Aspect 19: The method of any of Aspects 1 through 18, further comprising: receiving an indication of whether the initial set of probabilities includes quantized values, an ascending or descending order, or equal probabilities in at least one of a master information block (MIB), remaining minimum system information (RMSI), or other system information (OSI).

Aspect 20: The method of Aspect 19, wherein an initial SSB is selected during initial access from all SSBs broadcast, and the indication is the same for all initial SSBs.

Aspect 21: The method of Aspect 19, wherein the indication is included in system information associated with an initial SSB, wherein system information associated with different initial SSBs includes different indications.

Aspect 22: The method of any of Aspects 1 through 21, further comprising: adjusting the initial set of probabilities based on an interference measurement, a location associated with the UE, or a combination thereof, wherein the updated set of probabilities is based on the initial set of probabilities after the adjusting.

Aspect 23: The method of Aspect 22, wherein the interference measurement is associated with one or more random access preambles associated with at least one SSB included in the first set of SSBs.

Aspect 24: The method of any of Aspects 22 through 23, wherein the initial set of probabilities are adjusted using a formula indicated in remaining minimum system information (RMSI), other system information (OSI), or a combination thereof.

Aspect 25: The method of any of Aspects 22 through 24, wherein the initial set of probabilities are adjusted using a machine learning model.

Aspect 26: The method of Aspect 25, further comprising: selecting the machine learning model from a set of possible machine learning models based on an indication in remaining minimum system information (RMSI), other system information (OSI), or a combination thereof.

Aspect 27: The method of any of Aspects 25 through 26, wherein the machine learning model accepts, as input, at least one of: the interference measurement; the location associated with the UE; an index associated with an initial SSB associated with a highest signal strength measurement; the initial set of probabilities; or measurements of signal strength associated with the first set of SSBs.

Aspect 28: The method of any of Aspects 25 through 27, wherein the machine learning model outputs the initial set of probabilities after adjusting.

Aspect 29: The method of any of Aspects 1 through 28, wherein the first set of SSBs and the second set of SSBs are associated with a secondary serving cell within a secondary cell group (SCG), and the initial set of probabilities are indicated in a radio resource control (RRC) message associated with the secondary serving cell.

Aspect 30: The method of any of Aspects 1 through 29, wherein performing the random access procedure comprises: transmitting, concurrently, a plurality of initial random access messages using the SSB, and at least one additional SSB, selected from the second set of SSBs.

Aspect 31: The method of Aspect 30, wherein a quantity of the plurality of initial random access messages is indicated in remaining minimum system information (RMSI), other system information (OSI), or a combination thereof.

Aspect 32: The method of any of Aspects 30 through 31, further comprising: receiving a random access response (RAR) within a single RAR window associated with the SSB, and the at least one additional SSB, selected from the second set of SSBs.

Aspect 33: The method of any of Aspects 1 through 32, wherein performing the random access procedure comprises: transmitting an initial random access message using the SSB selected from the second set of SSBs according to a timer starting at a random access occasion associated with the SSB.

Aspect 34: The method of Aspect 33, wherein the timer is indicated in remaining minimum system information (RMSI), other system information (OSI), or a combination thereof.

Aspect 35: The method of any of Aspects 1 through 34, further comprising: transmitting an adjusted set of probabilities based on the initial set of probabilities after performing the random access procedure.

Aspect 36: The method of any of Aspects 1 through 35, further comprising: receiving one or more initial sets of probabilities associated with different initial SSBs.

Aspect 37: The method of any of Aspects 1 through 36, further comprising: receiving a new initial set of probabilities after performing the random access procedure.

Aspect 38: The method of Aspect 37, wherein the new initial set of probabilities are included in remaining minimum system information (RMSI), other system information (OSI), a cell-common paging message, or a combination thereof.

Aspect 39: The method of Aspect 37, wherein the new initial set of probabilities are included in a broadcast radio resource control (RRC) message.

Aspect 40: The method of Aspect 37, wherein the new initial set of probabilities are included in a UE-specific radio resource control (RRC) message.

Aspect 41: A method of wireless communication performed by a network entity, comprising: transmitting an initial set of probabilities, associated with a first set of synchronization signal blocks (SSBs), indicating chances of using SSBs within the first set for a random access procedure; and performing, with a user equipment (UE), the random access procedure with an SSB that was selected based at least in part on the initial set of probabilities.

Aspect 42: The method of Aspect 41, wherein the set of probabilities are included in remaining minimum system information (RMSI), other system information (OSI), or a combination thereof.

Aspect 43: The method of any of Aspects 41 through 42, further comprising: transmitting an indication of a second set of SSBs, wherein the SSB is selected from the second set of SSBs.

Aspect 44: The method of Aspect 43, wherein the second set of SSBs are indicated in remaining minimum system information (RMSI), other system information (OSI), or a combination thereof.

Aspect 45: The method of any of Aspects 41 through 44, further comprising: transmitting an indication of a machine learning model, from a set of possible machine learning models, in remaining minimum system information (RMSI), other system information (OSI), or a combination thereof, wherein the SSB is selected based at least in part on the machine learning model.

Aspect 46: The method of Aspect 45, wherein an initial SSB is selected during initial access from all SSBs broadcast, and the machine learning model is applied for all initial SSBs.

Aspect 47: The method of Aspect 45, wherein the machine learning model is indicated by system information associated with an initial SSB, wherein system information associated with different initial SSBs indicates different machine learning models.

Aspect 48: The method of any of Aspects 41 through 47, wherein an initial SSB is selected during initial access from all SSBs broadcast, and the initial set of probabilities is the same for all initial SSBs.

Aspect 49: The method of any of Aspects 41 through 47, wherein the initial set of probabilities is indicated by system information associated with an initial SSB, wherein system information associated with different initial SSBs indicates different initial sets of probabilities.

Aspect 50: The method of any of Aspects 41 through 49, wherein the initial set of probabilities includes quantized values associated with the first set of SSBs.

Aspect 51: The method of any of Aspects 41 through 49, wherein the initial set of probabilities includes an ascending order, or a descending order, of probabilities associated with the first set of SSBs.

Aspect 52: The method of any of Aspects 41 through 49, wherein the initial set of probabilities includes equal probabilities for SSBs included in the first set.

Aspect 53: The method of any of Aspects 41 through 52, further comprising: transmitting an indication of whether the initial set of probabilities includes quantized values, an ascending or descending order, or equal probabilities in at least one of a master information block (MIB), remaining minimum system information (RMSI), or other system information (OSI).

Aspect 54: The method of Aspect 53, wherein an initial SSB is selected during initial access from all SSBs broadcast, and the indication is the same for all initial SSBs.

Aspect 55: The method of Aspect 53, wherein the indication is included in system information associated with an initial SSB, wherein system information associated with different initial SSBs includes different indications.

Aspect 56: The method of any of Aspects 41 through 55, further comprising: transmitting an indication of a formula in remaining minimum system information (RMSI), other system information (OSI), or a combination thereof, wherein the initial set of probabilities are adjusted based on the formula.

Aspect 57: The method of any of Aspects 41 through 56, further comprising: transmitting an indication of a machine learning model, from a set of possible machine learning models, in remaining minimum system information (RMSI), other system information (OSI), or a combination thereof, wherein the initial set of probabilities are adjusted based on the machine learning model.

Aspect 58: The method of any of Aspects 41 through 57, wherein the first set of SSBs are associated with a secondary serving cell within a secondary cell group (SCG), and the initial set of probabilities are indicated in a radio resource control (RRC) message associated with the secondary serving cell.

Aspect 59: The method of any of Aspects 41 through 58, wherein performing the random access procedure comprises: receiving, concurrently, a plurality of initial random access messages using the SSB, and at least one additional SSB, that were selected based at least in part on the initial set of probabilities.

Aspect 60: The method of Aspect 59, wherein a quantity of the plurality of initial random access messages is indicated in remaining minimum system information (RMSI), other system information (OSI), or a combination thereof.

Aspect 61: The method of any of Aspects 59 through 60, further comprising: transmitting a random access response (RAR) within a single RAR window associated with the SSB, and the at least one additional SSB, that were selected based at least in part on the initial set of probabilities.

Aspect 62: The method of any of Aspects 59 through 61, further comprising: transmitting a plurality of random access responses (RARs); and receiving, using blind decoding, a subsequent message in response to one RAR of the plurality of RARs.

Aspect 63: The method of any of Aspects 41 through 62, wherein performing the random access procedure comprises: receiving an initial random access message using the SSB that was selected based at least in part on the initial set of probabilities according to a timer starting at a random access occasion associated with the SSB.

Aspect 64: The method of Aspect 63, wherein the timer is indicated in remaining minimum system information (RMSI), other system information (OSI), or a combination thereof.

Aspect 65: The method of any of Aspects 41 through 64, further comprising: receiving an adjusted set of probabilities based on the initial set of probabilities after performing the random access procedure.

Aspect 66: The method of any of Aspects 41 through 65, further comprising: transmitting one or more initial sets of probabilities associated with different initial SSBs.

Aspect 67: The method of any of Aspects 41 through 66, further comprising: transmitting a new initial set of probabilities after performing the random access procedure.

Aspect 68: The method of Aspect 67, wherein the new initial set of probabilities are included in remaining minimum system information (RMSI), other system information (OSI), a cell-common paging message, or a combination thereof.

Aspect 69: The method of Aspect 67, wherein the new initial set of probabilities are included in a broadcast radio resource control (RRC) message.

Aspect 70: The method of Aspect 67, wherein the new initial set of probabilities are included in a UE-specific radio resource control (RRC) message.

Aspect 71: An apparatus for wireless communication at a device, comprising a processor; memory coupled with the processor; and instructions stored in the memory and executable by the processor to cause the apparatus to perform the method of one or more of Aspects 1-40.

Aspect 72: A device for wireless communication, comprising a memory and one or more processors coupled to the memory, the one or more processors configured to perform the method of one or more of Aspects 1-40.

Aspect 73: An apparatus for wireless communication, comprising at least one means for performing the method of one or more of Aspects 1-40.

Aspect 74: A non-transitory computer-readable medium storing code for wireless communication, the code comprising instructions executable by a processor to perform the method of one or more of Aspects 1-40.

Aspect 75: A non-transitory computer-readable medium storing a set of instructions for wireless communication, the set of instructions comprising one or more instructions that, when executed by one or more processors of a device, cause the device to perform the method of one or more of Aspects 1-40.

Aspect 76: An apparatus for wireless communication at a device, comprising a processor; memory coupled with the processor; and instructions stored in the memory and executable by the processor to cause the apparatus to perform the method of one or more of Aspects 41-70.

Aspect 77: A device for wireless communication, comprising a memory and one or more processors coupled to the memory, the one or more processors configured to perform the method of one or more of Aspects 41-70.

Aspect 78: An apparatus for wireless communication, comprising at least one means for performing the method of one or more of Aspects 41-70.

Aspect 79: A non-transitory computer-readable medium storing code for wireless communication, the code comprising instructions executable by a processor to perform the method of one or more of Aspects 41-70.

Aspect 80: A non-transitory computer-readable medium storing a set of instructions for wireless communication, the set of instructions comprising one or more instructions that, when executed by one or more processors of a device, cause the device to perform the method of one or more of Aspects 41-70.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive an initial set of probabilities, associated with a first set of synchronization signal blocks (SSBs), indicating chances of using SSBs within the first set for a random access procedure;
determine an updated set of probabilities, associated with a second set of SSBs, based on the initial set of probabilities and indicating chances of using SSBs within the second set for the random access procedure; and
perform the random access procedure with an SSB selected from the second set of SSBs.

2. The apparatus of claim 1, wherein the set of probabilities are included in remaining minimum system information (RMSI), other system information (OSI), or a combination thereof.

3. The apparatus of claim 1, wherein the one or more processors are further configured to:
attempt a previous random access procedure using an initial SSB selected based on a signal strength associated with the initial SSB,
wherein the first set of SSBs does not include the initial SSB.

4. The apparatus of claim 1, wherein the updated set of probabilities is determined using a machine learning model.

5. The apparatus of claim 4, wherein the one or more processors are further configured to:
select the machine learning model from a set of possible machine learning models based on an indication in remaining minimum system information (RMSI), other system information (OSI), or a combination thereof.

6. The apparatus of claim 4, wherein an initial SSB is selected during initial access from all SSBs broadcast, and the machine learning model is applied for all initial SSBs.

7. The apparatus of claim 4, wherein the machine learning model is indicated by system information associated with an initial SSB, wherein system information associated with different initial SSBs indicates different machine learning models.

8. The apparatus of claim 1, wherein an initial SSB is selected during initial access from all SSBs broadcast, and the initial set of probabilities is the same for all initial SSBs.

9. The apparatus of claim 1, wherein the initial set of probabilities is indicated by system information associated with an initial SSB, wherein system information associated with different initial SSBs indicates different initial sets of probabilities.

10. The apparatus of claim 1, wherein the one or more processors are further configured to:
adjust the initial set of probabilities based on an interference measurement, a location associated with the UE, or a combination thereof,
wherein the updated set of probabilities is based on the initial set of probabilities after the adjusting.

11. The apparatus of claim 1, wherein the first set of SSBs and the second set of SSBs are associated with a secondary serving cell within a secondary cell group (SCG), and the initial set of probabilities are indicated in a radio resource control (RRC) message associated with the secondary serving cell.

12. The apparatus of claim 1, wherein, to perform the random access procedure, the one or more processors are configured to:
transmit, concurrently, a plurality of initial random access messages using the SSB, and at least one additional SSB, selected from the second set of SSBs.

13. The apparatus of claim 12, wherein the one or more processors are further configured to:
receive a random access response (RAR) within a single RAR window associated with the SSB, and the at least one additional SSB, selected from the second set of SSBs.

14. The apparatus of claim 1, wherein, to perform the random access procedure, the one or more processors are configured to:
transmit an initial random access message using the SSB selected from the second set of SSBs according to a timer starting at a random access occasion associated with the SSB.

15. The apparatus of claim 1, wherein the one or more processors are further configured to:
transmit an adjusted set of probabilities based on the initial set of probabilities after performing the random access procedure.

16. The apparatus of claim 1, wherein the one or more processors are further configured to:
receive one or more initial sets of probabilities associated with different initial SSBs.

17. The apparatus of claim 1, wherein the one or more processors are further configured to:
receive a new initial set of probabilities after performing the random access procedure.

18. An apparatus for wireless communication at a network entity, comprising:
a memory; and
one or more processors, coupled to the memory, configured to:
transmit an initial set of probabilities, associated with a first set of synchronization signal blocks (SSBs), indicating chances of using SSBs within the first set for a random access procedure; and
perform, with a user equipment (UE), the random access procedure with an SSB that was selected based at least in part on the initial set of probabilities.

19. The apparatus of claim 18, wherein an initial SSB is selected during initial access from all SSBs broadcast, and the initial set of probabilities is the same for all initial SSBs.

20. The apparatus of claim 18, wherein the initial set of probabilities is indicated by system information associated with an initial SSB, wherein system information associated with different initial SSBs indicates different initial sets of probabilities.

21. The apparatus of claim 18, wherein the first set of SSBs are associated with a secondary serving cell within a secondary cell group (SCG), and the initial set of probabilities are indicated in a radio resource control (RRC) message associated with the secondary serving cell.

22. The apparatus of claim 18, wherein, to perform the random access procedure, the one or more processors are configured to:
receive, concurrently, a plurality of initial random access messages using the SSB, and at least one additional SSB, that were selected based at least in part on the initial set of probabilities.

23. The apparatus of claim 22, wherein the one or more processors are further configured to:
transmit a random access response (RAR) within a single RAR window associated with the SSB, and the at least one additional SSB, that were selected based at least in part on the initial set of probabilities.

24. The apparatus of claim 22, wherein the one or more processors are further configured to:
transmit a plurality of random access responses (RARs); and
receive, using blind decoding, a subsequent message in response to one RAR of the plurality of RARs.

25. The apparatus of claim 18, wherein, to perform the random access procedure, the one or more processors are configured to:
receive an initial random access message using the SSB that was selected based at least in part on the initial set of probabilities according to a timer starting at a random access occasion associated with the SSB.

26. The apparatus of claim 18, wherein the one or more processors are further configured to:
receive an adjusted set of probabilities based on the initial set of probabilities after performing the random access procedure.

27. The apparatus of claim 18, wherein the one or more processors are further configured to:
transmit one or more initial sets of probabilities associated with different initial SSBs.

28. The apparatus of claim 18, wherein the one or more processors are further configured to:
transmit a new initial set of probabilities after performing the random access procedure.

29. A method of wireless communication performed by a user equipment (UE), comprising:
receiving an initial set of probabilities, associated with a first set of synchronization signal blocks (SSBs), indicating chances of using SSBs within the first set for a random access procedure;
determining an updated set of probabilities, associated with a second set of SSBs, based on the initial set of probabilities and indicating chances of using SSBs within the second set for the random access procedure; and
performing the random access procedure with an SSB selected from the second set of SSBs.

30. A method of wireless communication performed by a network entity, comprising:
transmitting an initial set of probabilities, associated with a first set of synchronization signal blocks (SSBs), indicating chances of using SSBs within the first set for a random access procedure; and
performing, with a user equipment (UE), the random access procedure with an SSB that was selected based at least in part on the initial set of probabilities.
